(19) United States
(12) Patent Application Publication
(10) Pub. No.: US 2018/0372182 A1
(43) Pub. Date: Dec. 27, 2018

(54) VIBRATION DAMPING DEVICE

(71) Applicant: AISIN AW CO., LTD., Anjo-shi, Aichi-ken (JP)

(72) Inventors: Yoshihiro TAKIKAWA, Tsushima (JP); Hiroki NAGAI, Anjo (JP); Masaki WAJIMA, Nagoya (JP); Takao SAKAMOTO, Anjo (JP)

(73) Assignee: AISIN AW CO., LTD., Anjo-shi, Aichi-ken (JP)

(21) Appl. No.: 15/748,741

(22) PCT Filed: Sep. 30, 2016
(86) PCT No.: PCT/JP2016/079028

§ 371 Date: Jan. 30, 2018

(30) Foreign Application Priority Data
Sep. 30, 2015 (JP) 2015-194653

(51) Int. Cl. F16F 15/14

(52) U.S. Cl. CPC F16F 15/1471; F16F 15/13469

(57) ABSTRACT

A vibration damping device is provided with a first coupling shaft and a a second coupling shaft supported by one of a restoring force generation member and an inertial mass body to couple the restoring force generation member and the inertial mass body so that the restoring force generation member and the inertial mass body are rotatable relative to each other; and a guide portion formed in the other of the restoring force generation member and the inertial mass body to guide the second coupling shaft. The second coupling shaft swings about the first coupling shaft while keeping the interaxial distance between the shafts constant, and swings about a virtual axis, the relative position of which with respect to the inertial mass body is determined to be invariable, while keeping the interaxial distance between the virtual axis and the second coupling shaft constant.

### CROSS REFERENCE TO RELATED APPLICATIONS

This application is a National Stage of Internal Application No. PCT/JP2016/079028 filed Sep. 30, 2016, claiming priority based on Japanese Patent Application No. 2015-194653 filed Sep. 30, 2015, the contents of all of which are incorporated herein by reference in their entirety.

### TECHNICAL FIELD

The present disclosure relates to a vibration damping device that damps vibration of a rotary element.

### BACKGROUND ART

There has hitherto been known a damper that includes: a link mechanism that includes a first link that serves as a crank member coupled to a crankshaft and a second link that serves as a connecting rod coupled to the first link; and an annular inertial body coupled to the second link and coupled so as to be turnable by a predetermined angle relative to the crankshaft via the link mechanism (see Patent Document 1, for example). In the damper, the point of coupling between the crankshaft and the first link is spaced away in the circumferential direction from the point of coupling between the inertial body and the second link, and a mass body is formed on the first link. The first link and the second link of the link mechanism operate to keep a state in which the first link and the second link are balanced with respective centrifugal forces that act thereon when the crankshaft is rotated. Therefore, a force (a force in the rotational direction) that acts to keep the link mechanism in an equilibrium state (balanced state) acts on the inertial body, and such a force causes the inertial body to make motion that is generally similar to that made when the inertial body is coupled to a rotary shaft via a spring member. Consequently, with the link mechanism functioning as a spring member and with the inertial body functioning as a mass body, twisting vibration caused in the crankshaft is reduced.

There has also hitherto been known a damper device that includes an input disk, a disk (inertial mass body) that has at least one arcuate groove and that is turnable relative to the input disk, a roller guided by the arcuate groove of the disk, and a coupling element rotatably coupled to the input disk and the roller (see Patent Document 2, for example). The damper device corresponds to the damper device described in Patent Document 1 in which the second link has been replaced with the arcuate groove and the roller.

### RELATED-ART DOCUMENTS

### Patent Documents

[Patent Document 1] Japanese Patent Application Publication No. 2001-263424 (JP 2001-263424 A)
[Patent Document 2] Specification of European Patent Application Publication No. 2899426

### SUMMARY

In the damper according to the related art described in Patent Document 1, a restoring force that acts to return the first link which serves as a crank member and the second link which serves as a connecting rod to their positions in the equilibrium state depends on component forces of a centrifugal force that act on the crank member and the connecting rod. However, the component force of the centrifugal force which acts on the connecting rod is smaller than the component force of the centrifugal force which acts on the crank member. Therefore, in the case where the weight (moment of inertia) of the connecting rod is increased in order to secure the strength or the durability, the component force of the centrifugal force which acts on the crank member is also used to return the connecting rod to its position in the equilibrium state, and the vibration damping performance of the damper may be lowered unless the centrifugal force which acts on the crank member, that is, the weight of the crank member, is increased significantly. In the damper device described in Patent Document 2, meanwhile, an inflection point (location at which the curvature is varied) is present on the inner surface of the arcuate groove which guides the roller. Thus, the position of contact between the roller and the inner surface of the arcuate groove may be varied irregularly when the roller passes through the inflection point, which may cause a skid or bounce of the roller. When such a skid or bounce of the roller is caused, the vibration damping performance of the damper device may be lowered.

Thus, it is an aspect of the present disclosure to provide a vibration damping device that can further improve the vibration damping performance while suppressing an increase in weight or size of the entire device.

The present disclosure provides a vibration damping device that damps vibration of a rotary element, including: a support member that rotates about a center of rotation of the rotary element together with the rotary element; a restoring force generation member rotatably coupled to the support member via a first coupling shaft; an inertial mass body that is rotatable about the center of rotation; a second coupling shaft that is supported by one of the restoring force generation member and the inertial mass body and that couples the restoring force generation member and the inertial mass body so that the restoring force generation member and the inertial mass body are rotatable relative to each other; and a guide portion that is formed in the other of the restoring force generation member and the inertial mass body and that guides the second coupling shaft, along with rotation of the support member, such that the second coupling shaft swings about the first coupling shaft while keeping an interaxial distance between the first coupling shaft and the second coupling shaft constant, and such that the second coupling shaft swings about a virtual axis, a relative position of which with respect to the inertial mass body is determined to be invariable, while keeping an interaxial distance between the virtual axis and the second coupling shaft constant.

In the vibration damping device, the support member, the restoring force generation member, the inertial mass body, the first and second coupling shafts, and the guide portion substantially constitute a four-node rotary link mechanism in which the support member (rotary element) serves as a fixed node. Thus, it is possible to damp vibration of the rotary element by applying vibration that is opposite in phase to vibration of the rotary element from the inertial mass body to the rotary element, which rotates together with the support member, via the guide portion, the second coupling shaft, and the restoring force generation member along with rotation of the support member (rotary element). In the vibration damping device, a four-node rotary link mechanism can be constituted without using a link coupled to both the restoring force generation member and the inertial mass body, that is, a connecting member in a common four-node rotary link mechanism. Thus, it is possible to suppress an increase in weight or size of the entire vibration damping device. In addition, it is not necessary to provide a bearing such as a sliding bearing or a rolling bearing on the virtual axis, and thus the degree of freedom in setting of the interaxial distance between the second coupling shaft and the virtual axis, that is, the length of a connecting member in a common four-node rotary link mechanism. Thus, it is possible to easily improve the vibration damping performance of the vibration damping device by adjusting the interaxial distance. Further, a link coupled to both the restoring force generation member and the inertial mass body is not required, and thus a component force of the centrifugal force that acts on the restoring force generation member is not used to return the link which is coupled to both the restoring force generation member and the inertial mass body to its position in the equilibrium state. Thus, the vibration damping performance of the vibration damping device can be improved while suppressing an increase in weight of the restoring force generation member. In addition, it is possible to secure the vibration damping performance well by smoothly guiding the second coupling shaft using the guide portion by swinging the second coupling shaft about the virtual axis so as to keep the interaxial distance between the first coupling shaft and the second coupling shaft and the interaxial distance between the virtual axis and the second coupling shaft constant. As a result, with the vibration damping device, the vibration damping performance can be further improved while suppressing an increase in weight or size of the entire device.

### BRIEF DESCRIPTION OF THE DRAWINGS

FIG. 1 is a schematic diagram illustrating a starting device that includes a vibration damping device according to the present disclosure.

FIG. 2 is a sectional view of the starting device illustrated in FIG. 1.

FIG. 3 is a front view of the vibration damping device according to the present disclosure.

FIG. 4 is an enlarged sectional view illustrating an essential portion of the vibration damping device according to the present disclosure.

FIG. 5 is a front view illustrating operation of the vibration damping device according to the present disclosure.

FIGS. 6A, 6B, and 6C are each a schematic diagram illustrating operation of the vibration damping device according to the present disclosure.

FIG. 7 is a schematic diagram illustrating operation of the vibration damping device according to the present disclosure.

FIG. 8 is a front view illustrating operation of the vibration damping device according to the present disclosure.

FIG. 9 is a schematic diagram illustrating operation of a different vibration damping device according to the present disclosure.

FIGS. 10A, 10B, and 10C are each a schematic diagram illustrating operation of the different vibration damping device according to the present disclosure.

FIG. 11 is a chart illustrating the relationship between the vibration angle of a restoring force generation member included in the vibration damping device according to the present disclosure and the ratio of a restoring force to a centrifugal force that acts on the restoring force generation member.

FIG. 12 is a schematic diagram illustrating operation of the vibration damping device according to the present disclosure.

FIG. 13 is a schematic diagram illustrating operation of the different vibration damping device according to the present disclosure.

FIG. 14 is a chart illustrating the results of analyzing the relationship between the vibration angle of a mass body about the center of rotation and the order of vibration to be damped by the vibration damping device according to the present disclosure.

FIG. 15 is a schematic diagram illustrating still another vibration damping device according to the present disclosure.

FIG. 16 is a schematic diagram illustrating another vibration damping device according to the present disclosure.

FIG. 17 is a schematic diagram illustrating a modification of a damper device that includes the vibration damping device according to the present disclosure.

FIG. 18 is a schematic diagram illustrating another modification of the damper device which includes the vibration damping device according to the present disclosure.

### PREFERRED EMBODIMENT

Now, an embodiment of the present disclosure will be described with reference to the drawings.

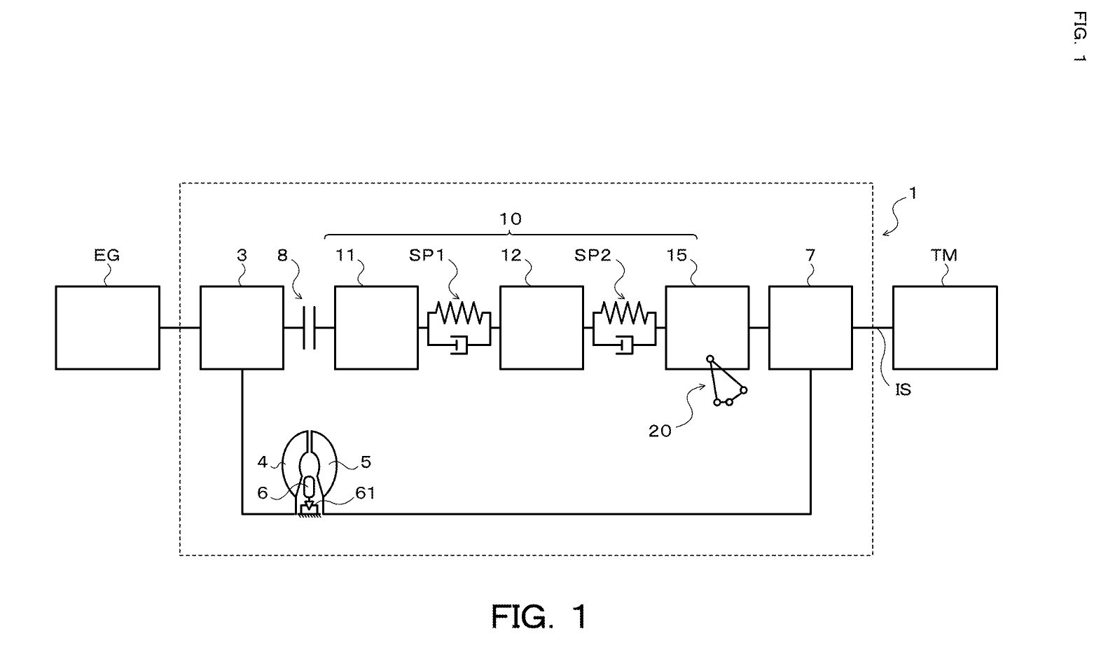

FIG. 1 is a schematic diagram illustrating a starting device 1 that includes a vibration damping device 20 according to the present disclosure. The starting device 1 illustrated in the drawing is mounted on a vehicle that includes an engine (internal combustion engine) EG that serves as a drive device, for example. In addition to the vibration damping device 20, the starting device 1 includes: a front cover 3 that serves as an input member coupled to a crankshaft of the engine EG; a pump impeller (input-side fluid transmission element) 4 fixed to the front cover 3 to rotate together with the front cover 3; a turbine runner (output-side fluid transmission element) 5 that is rotatable coaxially with the pump impeller 4; a damper hub 7 that serves as an output member fixed to an input shaft IS of a transmission (power transfer device) TM that is an automatic transmission (AT), a continuously variable transmission (CVT), a dual clutch transmission (DCT), a hybrid transmission, or a speed reducer; a lock-up clutch 8; a damper device 10; and so forth.

In the following description, unless specifically stated, the term “axial direction” basically indicates the direction of extension of the center axis (axis) of the starting device 1 or the damper device 10 (vibration damping device 20). In addition, unless specifically stated, the term “radial direction” basically indicates the radial direction of the starting device 1, the damper device 10, or a rotary element of the damper device 10 etc., that is, the direction of extension of a line that extends in directions (radial directions) that are orthogonal to the center axis of the starting device 1 or the damper device 10 from the center axis. Further, unless specifically stated, the term “circumferential direction” basically indicates the circumferential direction of the starting device 1, the damper device 10, or a rotary element of the damper device 10 etc., that is, a direction along the rotational direction of such a rotary element.

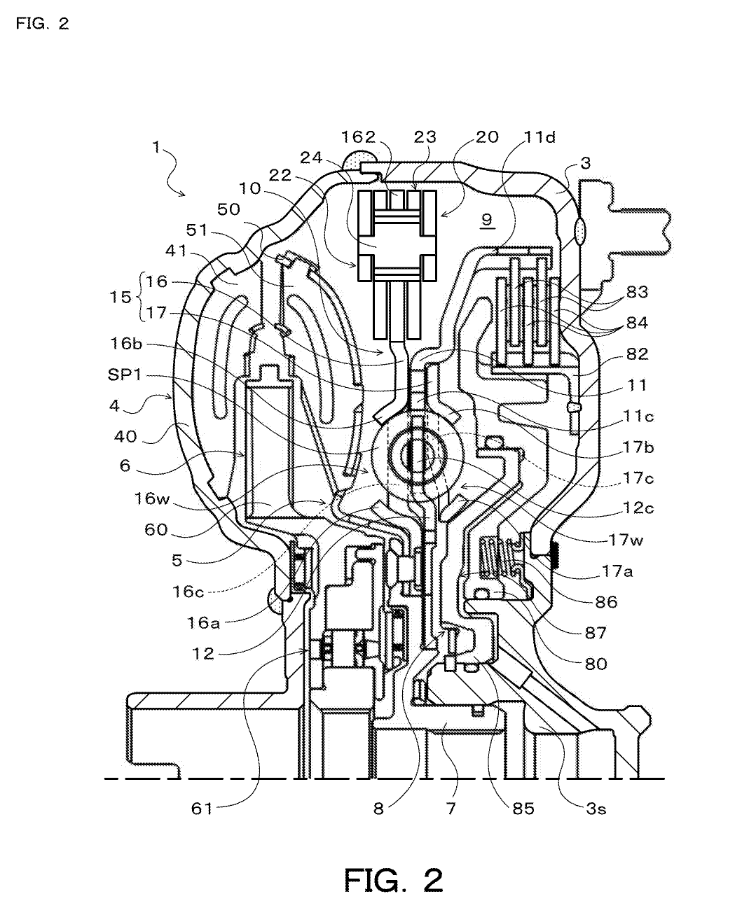

As illustrated in FIG. 2, the pump impeller 4 has a pump shell 40 tightly fixed to the front cover 3 and a plurality of pump blades 41 disposed on the inner surface of the pump shell 40. As illustrated in FIG. 2, the turbine runner 5 has a turbine shell 50 and a plurality of turbine blades 51 disposed on the inner surface of the turbine shell 50.

The inner peripheral portion of the turbine shell 50 is fixed to the damper hub 7 via a plurality of rivets.

The pump impeller 4 and the turbine runner 5 face each other. A stator 6 is disposed between and coaxially with the pump impeller 4 and the turbine runner 5. The stator 6 rectifies a flow of hydraulic oil (working fluid) from the turbine runner 5 to the pump impeller 4. The stator 6 has a plurality of stator blades 60. The rotational direction of the stator 6 is set to only one direction by a one-way clutch 61. The pump impeller 4, the turbine runner 5, and the stator 6 form a torus (annular flow passage) that allows circulation of hydraulic oil, and function as a torque converter (fluid transmission apparatus) with a torque amplification function. It should be noted, however, that the stator 6 and the one-way clutch 61 may be omitted from the starting device 1, and that the pump impeller 4 and the turbine runner 5 may function as a fluid coupling.

The lock-up clutch 8 is constituted as a hydraulic multi-plate clutch, and can establish and release lock-up in which the front cover 3 and the damper hub 7, that is, the input shaft IS of the transmission TM, are coupled to each other via the damper device 10. The lock-up clutch 8 includes: a lock-up piston 80 supported by a center piece 3s, which is fixed to the front cover 3, so as to be movable in the axial direction; a drum portion 11d that serves as a clutch drum integrated with a drive member 11 which is an input element of the damper device 10; an annular clutch hub 82 fixed to the inner surface of the front cover 3 so as to face the lock-up piston 80; a plurality of first friction engagement plates (friction plates having a friction material on both surfaces) 83 fitted with spines formed on the inner peripheral surface of the drum portion 11d; and a plurality of second friction engagement plates (separator plates) 84 fitted with splines formed on the outer peripheral surface of the clutch hub 82.

The lock-up clutch 8 further includes: an annular flange member (oil chamber defining member) 85 attached to the center piece 3s of the front cover 3 so as to be positioned on the opposite side of the lock-up piston 80 from the front cover 3, that is, on the damper device 10 side with respect to the lock-up piston 80; and a plurality of return springs 86 disposed between the front cover 3 and the lock-up piston 80. As illustrated in the drawing, the lock-up piston 80 and the flange member 85 define an engagement oil chamber 87. Hydraulic oil (engagement hydraulic pressure) is supplied to the engagement oil chamber 87 from a hydraulic control device (not illustrated). Increasing the engagement hydraulic pressure for the engagement oil chamber 87 moves the lock-up piston 80 in the axial direction so as to press the first and second friction engagement plates 83 and 84 toward the front cover 3, which can bring the lock-up clutch 8 into engagement (complete engagement or slip engagement). The lock-up clutch 8 may be constituted as a hydraulic single-plate clutch.

As illustrated in FIGS. 1 and 2, the damper device 10 includes, as rotary elements, the drive member (input element) 11 which includes the drum portion 11d, an intermediate member (intermediate element) 12, and a driven member (output element) 15. The damper device 10 further includes, as torque transfer elements, a plurality of (e.g. four each in the present embodiment) first springs (first elastic bodies) SP1 and second springs (second elastic bodies) SP2 disposed alternately at intervals in the circumferential direction on the same circumference. Arc coil springs, which are made of a metal material wound so as to have an axis that extends arcuately when no load is applied, or straight coil springs, which are made of a metal material spirally wound so as to have an axis that extends straight when no load is applied, are adopted as the first and second springs SP1 and SP2. As illustrated in the drawings, so-called double springs may be adopted as the first and second springs SP1 and SP2.

The drive member 11 of the damper device 10 is an annular member that includes the drum portion 11d on the outer peripheral side, and has a plurality of (e.g. four at intervals of 90° in the present embodiment) spring abutment portions 11c provided at intervals in the circumferential direction to extend radially inward from the inner peripheral portion. The intermediate member 12 is an annular plate-like member, and has a plurality of (e.g. four at intervals of 90° in the present embodiment) spring abutment portions 12c provided at intervals in the circumferential direction to extend radially inward from the outer peripheral portion. The intermediate member 12 is rotatably supported by the damper hub 7, and surrounded by the drive member 11 on the radially inner side of the drive member 11.

As illustrated in FIG. 2, the driven member 15 includes an annular first driven plate 16 and an annular second driven plate 17 coupled so as to rotate together with the first driven plate 16 via a plurality of rivets (not illustrated). The first driven plate 16 is constituted as a plate-like annular member, disposed in more proximity to the turbine runner 5 than the second driven plate 17, and fixed to the damper hub 7 via a plurality of rivets together with the turbine shell 50 of the turbine runner 5. The second driven plate 17 is constituted as a plate-like annular member that has an inside diameter that is smaller than that of the first driven plate 16, and the outer peripheral portion of the second driven plate 17 is fastened to the first driven plate 16 via a plurality of rivets (not illustrated).

The first driven plate 16 has: a plurality of (e.g. four in the present embodiment) spring housing windows 16w that extend arcuately and that are disposed at intervals (at equal intervals) in the circumferential direction; a plurality of (e.g. four in the present embodiment) spring support portions 16a that extend along the inner peripheral edges of the corresponding spring housing windows 16w and that are arranged at intervals (equal intervals) in the circumferential direction; a plurality of (e.g. four in the present embodiment) spring support portions 16b that extend along the outer peripheral edges of the corresponding spring housing windows 16w and that are arranged at intervals (equal intervals) in the circumferential direction to face the corresponding spring support portions 16a in the radial direction of the first driven plate 16; and a plurality of (e.g. four in the present embodiment) spring abutment portions 16c. The plurality of spring abutment portions 16c of the first driven plate 16 are provided such that each spring abutment portion 16c is interposed between the spring housing windows 16w (spring support portions 16a and 16b) which are adjacent to each other along the circumferential direction.

The second driven plate 17 also has: a plurality of (e.g. four in the present embodiment) spring housing windows 17w that extend arcuately and that are disposed at intervals (at equal intervals) in the circumferential direction; a plurality of (e.g. four in the present embodiment) spring support portions 17a that extend along the inner peripheral edges of the corresponding spring housing windows 17w and that are arranged at intervals (equal intervals) in the circumferential direction; a plurality of (e.g. four in the present embodiment) spring support portions 17b that extend along the outer peripheral edges of the corresponding spring housing windows 17w and that are arranged at intervals (equal intervals) in the circumferential direction to face the corresponding spring support portions 17a in the radial direction of the second driven plate 17; and a plurality of (e.g. four in the present embodiment) spring abutment portions 17c. The plurality of spring abutment portions 17c of the second driven plate 17 are provided such that each spring abutment portion 17c is interposed between two sets of spring support portions 17a and 17b (two spring housing windows) which are adjacent to each other along the circumferential direction. In the present embodiment, as illustrated in FIG. 2, the drive member 11 is rotatably supported by the outer peripheral surface of the second driven plate 17 which is supported by the damper hub 7 via the first driven plate 16. Consequently, the drive member 11 is aligned with the damper hub 7.

With the damper device 10 in the attached state, the first and second springs SP1 and SP2 are each disposed between the spring abutment portions 11c of the drive member 11 which are adjacent to each other, so as to be arranged alternately along the circumferential direction of the damper device 10. In addition, the spring abutment portions 12c of the intermediate member 12 are provided between the first and second springs SP1 and SP2, which are disposed between the spring abutment portions 11c which are adjacent to each other and which are paired with each other (act in series with each other), to abut against the end portions of such first and second springs SP1 and SP2. Consequently, with the damper device 10 in the attached state, the first end portion of each first spring SP1 abuts against the corresponding spring abutment portion 11c of the drive member 11, and the second end portion of each first spring SP1 abuts against the corresponding spring abutment portion 12c of the intermediate member 12. With the damper device 10 in the attached state, in addition, the first end portion of each second spring SP2 abuts against the corresponding spring abutment portion 12c of the intermediate member 12, and the second end portion of each second spring SP2 abuts against the corresponding spring abutment portion 11c of the drive member 11.

Meanwhile, as seen from FIG. 2, the plurality of spring support portions 16a of the first driven plate 16 support (guide) side portions of the corresponding set of first and second springs SP1 and SP2 on the turbine runner 5 side from the inner peripheral side. In addition, the plurality of spring support portions 16b support (guide) the side portions of the corresponding set of first and second springs SP1 and SP2 on the turbine runner 5 side from the outer peripheral side. Further, as seen from FIG. 2, the plurality of spring support portions 17a of the second driven plate 17 support (guide) side portions of the corresponding set of first and second springs SP1 and SP2 on the lock-up piston 80 side from the inner peripheral side. In addition, the plurality of spring support portions 17b support (guide) the side portions of the corresponding set of first and second springs SP1 and SP2 on the lock-up piston 80 side from the outer peripheral side.

In addition, with the damper device 10 in the attached state, as with the spring abutment portions 11c of the drive member 11, the spring abutment portions 16c and the spring abutment portions 17c of the driven member 15 are provided between the first and second springs SP1 and SP2, which are not paired with each other (do not act in series with each other), to abut against the end portions of such first and second springs SP1 and SP2. Consequently, with the damper device 10 in the attached state, the first end portion of each first spring SP1 also abuts against the corresponding spring abutment portions 16c and 17c of the driven member 15, and the second end portion of each second spring SP2 also abuts against the corresponding spring abutment portions 16c and 17c of the driven member 15. As a result, the driven member 15 is coupled to the drive member 11 via the plurality of first springs SP1, the intermediate member 12, and the plurality of second springs SP2, and the first and second springs SP1 and SP2 which are paired with each other are coupled in series with each other via the spring abutment portion 12c of the intermediate member 12 between the drive member 11 and the driven member 15. In the present embodiment, the distance between the axis of the starting device 1 and the damper device 10 and the axis of the first springs SP1 and the distance between the axis of the starting device 1 etc. and the axis of the second springs SP2 are equal to each other.

The damper device 10 according to the present embodiment further includes: a first stopper that regulates relative rotation between the intermediate member 12 and the driven member 15 and deflection of the second springs SP2; and a second stopper that regulates relative rotation between the drive member 11 and the driven member 15. The first stopper is configured to regulate relative rotation between the intermediate member 12 and the driven member 15 when input torque transferred from the engine EG to the drive member 11 has reached torque (first threshold) T1 that is determined in advance and that is less than torque T2 (second threshold) corresponding to a maximum torsional angle θmax of the damper device 10. In addition, the second stopper is configured to regulate relative rotation between the drive member 11 and the driven member 15 when torque input to the drive member 11 has reached the torque T2 corresponding to the maximum torsional angle θmax. Consequently, the damper device 10 has damping characteristics in two stages. The first stopper may be configured to regulate relative rotation between the drive member 11 and the intermediate member 12 and deflection of the first springs SP1. The damper device 10 may also be provided with: a stopper that regulates relative rotation between the drive member 11 and the intermediate member 12 and deflection of the first springs SP1; and a stopper that regulates relative rotation between the intermediate member 12 and the driven member 15 and deflection of the second springs SP2.

The vibration damping device 20 is coupled to the driven member 15 of the damper device 10, and disposed inside the fluid transmission chamber 9 which is filled with hydraulic oil. As illustrated in FIGS. 2 to 4, the vibration damping device 20 includes: the first driven plate 16 which serves as a support member (first link); a plurality of (e.g. four in the present embodiment) crank members 22 that serve as a restoring force generation member (second link) rotatably coupled to the first driven plate 16 via respective first coupling shafts 21; a single annular inertial mass body (third link) 23; and a plurality of (e.g. four in the present embodiment) second coupling shafts 24 that couple the corresponding crank members 22 and the inertial mass body 23 so as to be rotatable relative to each other.

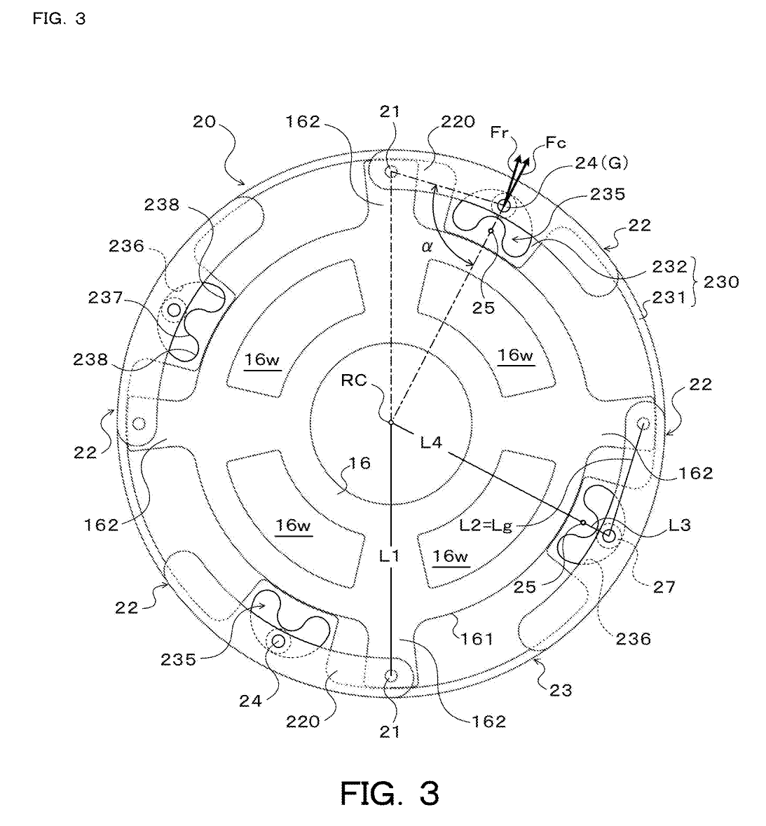

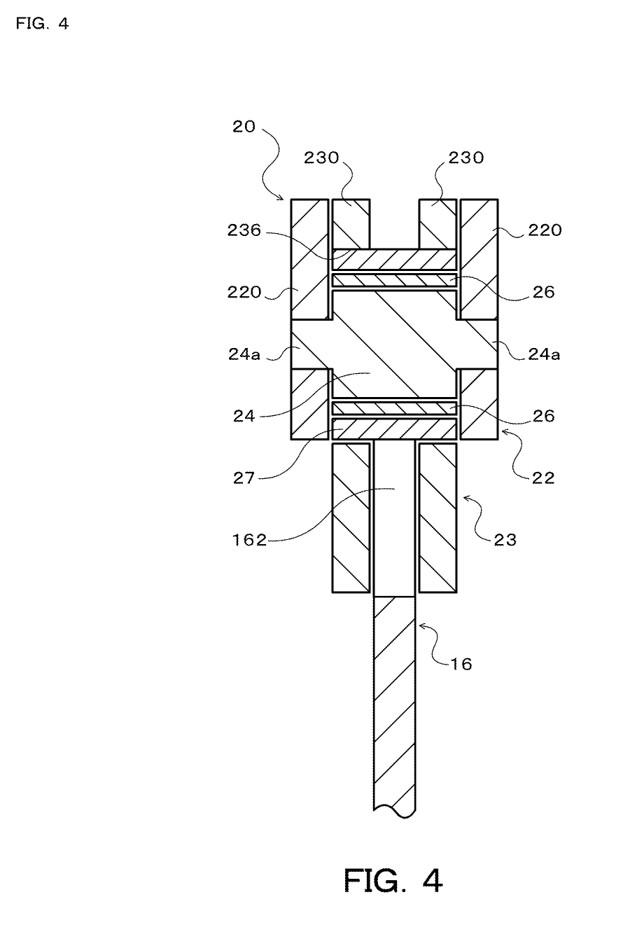

As illustrated in FIG. 3, the first driven plate 16 has a plurality of (e.g. four in the present embodiment) projecting support portions 162 formed at intervals (equal intervals) in the circumferential direction to project radially outward from an outer peripheral surface 161. As illustrated in the drawing, first end portions of the crank members 22 are rotatably coupled to the corresponding projecting support portions 162 of the first driven plate 16 via the first coupling shafts 21 (see FIG. 3). In the present embodiment, as illustrated in FIG. 4, each of the crank members 22 has two plate members 220. The plate members 220 are formed of a metal plate so as to have an arcuate planar shape. In the present embodiment, the radius of curvature of the outer peripheral edges of the plate members 220 is determined to be the same as the radius of curvature of the outer peripheral edge of the inertial mass body 23.

The two plate members 220 face each other in the axial direction of the damper device 10 via the corresponding projecting support portion 162 and the inertial mass body 23, and are coupled to each other via the first coupling shaft 21. In the present embodiment, the first coupling shafts 21 are each a rivet inserted through coupling holes (circular holes) that serve as sliding bearing portions formed in the projecting support portions 162 of the first driven plate 16 and coupling holes (circular holes) that serve as sliding bearing portions formed in the plate members 220, and with both ends clinched. Consequently, the first driven plate 16 (driven member 15) and each of the crank members 22 constitute a turning pair. The first coupling shafts 21 may be inserted through coupling holes that serve as sliding bearing portions formed in the projecting support portions 162 and one of the two plate members 220, and supported (fitted or fixed) by the other. A rolling bearing such as a ball bearing may be disposed in at least one of a space between the plate member 220 and the first coupling shaft 21 and a space between the projecting support portion 162 and the first coupling shaft 21.

The inertial mass body 23 includes two annular members 230 formed of a metal plate. The weight of the inertial mass body 23 (two annular members 230) is determined to be sufficiently larger than the weight of one crank member 22. As illustrated in FIGS. 3 and 4, the annular members 230 each have: a short cylindrical (annular) main body 231; and a plurality of (e.g. four in the present embodiment) projecting portions 232 provided at intervals (equal intervals) in the circumferential direction to project radially inward from the inner peripheral surface of the main body 231. The two annular members 230 are coupled to each other via a fixing member (not illustrated) such that the projecting portions 232 face each other in the axial direction of the annular members 230.

The projecting portions 232 are each formed with a guide portion 235 that guides the second coupling shaft 24 which couples the crank member 22 and the inertial mass body 23 to each other. The guide portion 235 is an opening portion that extends arcuately, and includes: a guide surface 236 in a recessed curved surface shape; a support surface 237 in a projecting curved surface shape provided on the inner side (closer to the center of the annular members 230) in the radial direction of the annular member (first driven plate 16) with respect to the guide surface 236 to face the guide surface 236; and two stopper surfaces 238 that are continuous with the guide surface 236 and the support surface 237 on both sides of the guide surface 236 and the support surface 237. The guide surface 236 is a recessed circular columnar surface that has a constant radius of curvature. The support surface 237 is a projecting curved surface that extends arcuately. The stopper surfaces 238 are each a recessed curved surface that extends arcuately. As illustrated in FIG. 3, the guide portion 235 (the guide surface 236, the support surface 237, and the stopper surfaces 238) are formed to be symmetrical with respect to a line that passes through the center of curvature of the guide surface 236 and the center of the annular members 230 (center of rotation RC of the first driven plate 16). In the vibration damping device 20, a line that passes through the center of curvature of the guide surface 236 and that is orthogonal to the projecting portion 232 (annular members 230) is determined as a virtual axis 25, the relative position of which with respect to the two annular members 230, that is, the inertial mass body 23, is invariable (which is not movable with respect to the inertial mass body 23). Consequently, the center of curvature of the guide surface 236 coincides with the virtual axis 25.

The second coupling shaft 24 is formed in a solid (or hollow) round bar shape, and has two protruding portions 24a in a round bar shape, for example, that project toward the outer side in the axial direction from both ends of the second coupling shaft 24. As illustrated in FIG. 4, the two protruding portions 24a of the second coupling shaft 24 are fitted (fixed) with respective coupling holes (circular holes) formed in the plate members 220 of the crank member 22. In the present embodiment, the coupling hole of the plate member 220, with which the protruding portion 24a is fitted, is formed in the plate member 220 such that the center of the coupling hole extends coaxially with a line that passes through a center of gravity G of the crank member 22 (around the center portion of the plate member 220 in the longitudinal direction). Consequently, the length from the center of the first coupling shaft 21, which couples the first driven plate 16 (projecting support portion 162) and the crank member 22 to each other, to the center of gravity G of the crank member 22 coincides with the interaxial distance (center distance) between the first coupling shaft 21 and the second coupling shaft 24, which couples the crank member 22 and the inertial mass body 23 to each other. In addition, the other end portion of the crank member 22 (plate members 220) is positioned on the opposite side of the second coupling shaft 24 from the first coupling shaft 21. The protruding portions 24a of the second coupling shaft 24 may be inserted through coupling holes (circular holes) that serve as sliding bearing portions formed in the plate members 220 of the crank member 22. That is, the second coupling shaft 24 may be rotatably supported from both sides by the two plate members, that is, the crank member 22. Further, a rolling bearing such as a ball bearing may be disposed between the plate member 220 and the protruding portion 24a of the second coupling shaft 24.

As illustrated in FIG. 4, the second coupling shaft 24 rotatably supports a cylindrical outer ring 27 via a plurality of rollers (rolling bodies) 26. The outside diameter of the outer ring 27 is determined to be slightly smaller than the spacing between the guide surface 236 and the support surface 237 of the guide portion 235. The second coupling shaft 24 and the outer ring 27 are supported by the crank member 22, and disposed in the corresponding guide portion 235 of the inertial mass body 23 such that the outer ring 27 rolls on the guide surface 236. Consequently, the inertial mass body 23 is disposed coaxially with the center of rotation RC of the first driven plate 16 and so as to be rotatable about the center of rotation RC. In addition, the plurality of rollers 26, the outer ring 27, and the second coupling shaft 24 constitute a rolling bearing. Thus, relative rotation between the crank members 22 and the inertial mass body 23 is allowed, and each of the crank members 22 and the inertial mass body 23 constitute a turning pair. A plurality of balls may be disposed between the second coupling shaft 24 and the outer ring 27 in place of the plurality of rollers 26.

In the vibration damping device 20, as discussed above, the first driven plate 16 (driven member 15) and each of the crank members 22 constitute a turning pair, and each of the crank members 22 and the second coupling shaft 24 which is guided by the guide portion 235 of the inertial mass body 23 constitute a turning pair. In addition, the inertial mass body 23 is disposed so as to be rotatable about the center of rotation RC of the first driven plate 16. Consequently, when the first driven plate 16 is rotated in one direction, each of the second coupling shafts 24 is moved in conjunction with the second link while being guided by the guide portion 235 of the inertial mass body 23 to make swinging motion (reciprocal rotational motion) about the first coupling shaft 21 while keeping the interaxial distance between the first coupling shaft 21 and the second coupling shaft 24 constant, and to make swinging motion (reciprocal rotational motion) about the virtual axis 25 while keeping the interaxial distance between the virtual axis 25 and the second coupling shaft 24 constant. That is, each of the crank members 22 makes swinging motion about the first coupling shaft 21 in accordance with movement of the second coupling shaft 24, and the virtual axis 25 and the inertial mass body 23 make swinging motion about the second coupling shaft 24 which makes movement, and make swinging motion (reciprocal rotational motion) about the center of rotation RC of the first driven plate 16. As a result, the first driven plate 16, the crank members 22, the inertial mass body 23, the first and second coupling shafts 21 and 24, and the guide portions 235 substantially constitute a four-node rotary link mechanism in which the first driven plate 16 serves as a fixed node.

In the present embodiment, further, when the interaxial distance between the center of rotation RC of the first driven plate 16 and the first coupling shaft 21 is defined as “L1”, the interaxial distance between the first coupling shaft 21 and the second coupling shaft 24 is defined as “L2”, the interaxial distance between the second coupling shaft 24 and the virtual axis 25 is defined as “L3”, and the interaxial distance between the virtual axis 25 and the center of rotation RC is defined as “L4” (see FIG. 2), the first driven plate 16, the crank members 22, the inertial mass body 23, the second coupling shafts 24, and the guide portions 235 of the inertial mass body 23 are configured to meet the relationship L1+L2>L3+L4. In the present embodiment, in addition, the interaxial distance L3 between the second coupling shaft 24 and the virtual axis 25 (the radius of curvature of the guide surface 236 minus the radius of the outer ring 27) is determined to be shorter than the interaxial distances L1, L2, and L4, and as short as possible in the range in which operation of the crank members 22 and the inertial mass body 23 is not hindered. In the present embodiment, further, the first driven member 16 (projecting support portions 162) which serves as the first link is configured such that the interaxial distance L1 between the center of rotation RC and the first coupling shaft 21 is longer than the interaxial distances L2, L3, and L4.

Consequently, in the vibration damping device 20 according to the present embodiment, the relationship L1>L4>L2>L3 is met, and the first driven plate 16, the crank members 22, the inertial mass body 23, the first and second coupling shafts 21 and 24, and the guide portions 235 substantially constitute a double lever mechanism in which the first driven plate 16 which faces a line segment (virtual link) that connects between the second coupling shaft 24 and the virtual axis 25 serves as a fixed node. Additionally, in the vibration damping device 20 according to the present embodiment, when the length from the center of the first coupling shaft 21 to the center of gravity G of the crank member 22 is defined as “Lg”, the relationship Lg=L2 is met.

In addition, the “equilibrium state (balanced state)” of the vibration damping device 20 corresponds to a state in which the resultant force of the total of centrifugal forces that act on the constituent elements of the vibration damping device 20 and forces that act on the centers of the first and second coupling shafts 21 and 24 of the vibration damping device 20 and the center of rotation RC is zero. When the vibration damping device 20 is in the equilibrium state, as illustrated in FIG. 3, the center of the second coupling shaft 24, the center of the virtual axis 25, and the center of rotation RC of the first driven plate 16 are positioned on one line. Further, the vibration damping device 20 according to the present embodiment is configured to meet 60° a 120°, more preferably 70° a 90°, when the angle formed by the direction from the center of the first coupling shaft 21 toward the center of the second coupling shaft 24 and the direction from the center of the second coupling shaft 24 toward the center of rotation RC of the first driven plate 16 in the equilibrium state in which the center of the second coupling shaft 24, the center of the virtual axis 25, and the center of rotation RC are positioned on one line is defined as “a”.

In the starting device 1 which includes the damper device 10 and the vibration damping device 20, when lock-up is released by the lock-up clutch 8, as seen from FIG. 1, torque (power) from the engine EG which serves as a motor is transferred to the input shaft IS of the transmission TM via a path that includes the front cover 3, the pump impeller 4, the turbine runner 5, and the damper hub 7. Meanwhile, when lock-up is established by the lock-up clutch 8, as seen from FIG. 1, torque (power) from the engine EG is transferred to the input shaft IS of the transmission TM via a path that includes the front cover 3, the lock-up clutch 8, the drive member 11, the first springs SP1, the intermediate member 12, the second springs SP2, the driven member 15, and the damper hub 7.

When the drive member 11 which is coupled to the front cover 3 by the lock-up clutch 8 is rotated along with rotation of the engine EG while lock-up is established by the lock-up clutch 8, the first and second springs SP1 and SP2 act in series with each other via the intermediate member 12 between the drive member 11 and the driven member 15 until torque input to the drive member 11 reaches the torque T1. Consequently, torque from the engine EG transferred to the front cover 3 is transferred to the input shaft IS of the transmission TM, and fluctuations in torque from the engine EG are damped (absorbed) by the first and second springs SP1 and SP2 of the damper device 10. When torque input to the drive member 11 becomes equal to or more than the torque T1, meanwhile, fluctuations in torque from the engine EG are damped (absorbed) by the first springs SP1 of the damper device 10 until the input torque reaches the torque T2.

In the starting device 1, further, when the damper device 10, which is coupled to the front cover 3 by the lock-up clutch 8 along with establishment of lock-up, is rotated together with the front cover 3, the first driven plate 16 (driven member 15) of the damper device 10 is also rotated in the same direction as the front cover 3 about the axis of the starting device 1. Along with rotation of the first driven plate 16, the crank members 22 and the inertial mass body 23 which constitute the vibration damping device 20 are swung with respect to the first driven plate 16, and accordingly vibration transferred from the engine EG to the first driven plate 16 is damped also by the vibration damping device 20. That is, the vibration damping device 20 is configured such that the order (vibration order q) of swinging motion of the crank members 22 and the inertial mass body 23 coincides with the order of vibration transferred from the engine EG to the first driven plate 16 (1.5th order in the case where the engine EG is e.g. a three-cylinder engine, and second order in the case where the engine EG is e.g. a four-cylinder engine), and damps vibration transferred from the engine EG to the first driven plate 16 irrespective of the rotational speed of the engine EG (first driven plate 16).

Consequently, it is possible to damp vibration significantly well using both the damper device 10 and the vibration damping device 20 while suppressing an increase in weight of the damper device 10.

Next, operation of the vibration damping device 20 will be described in detail.

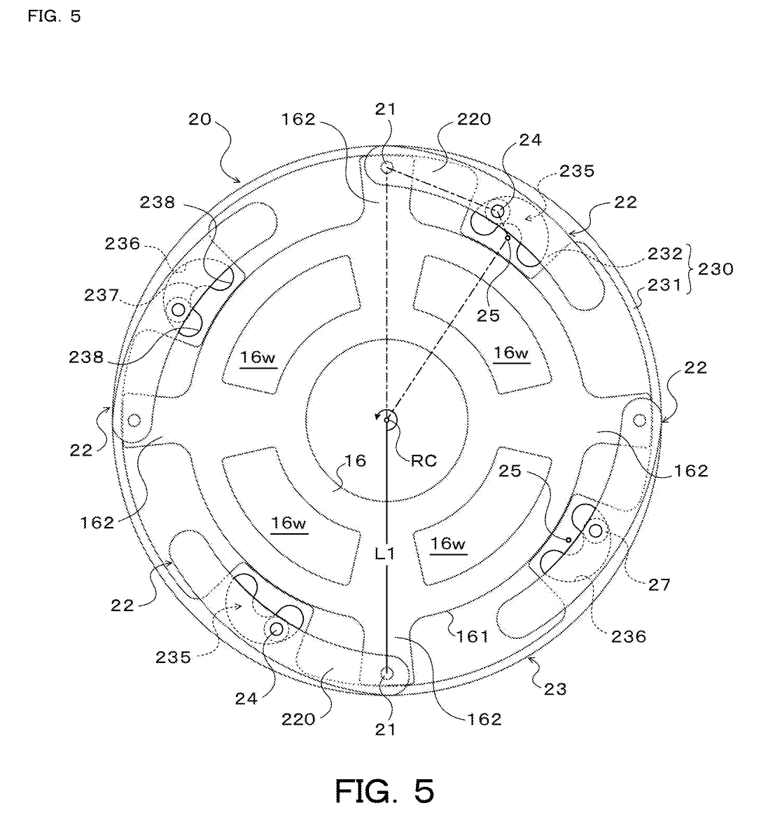

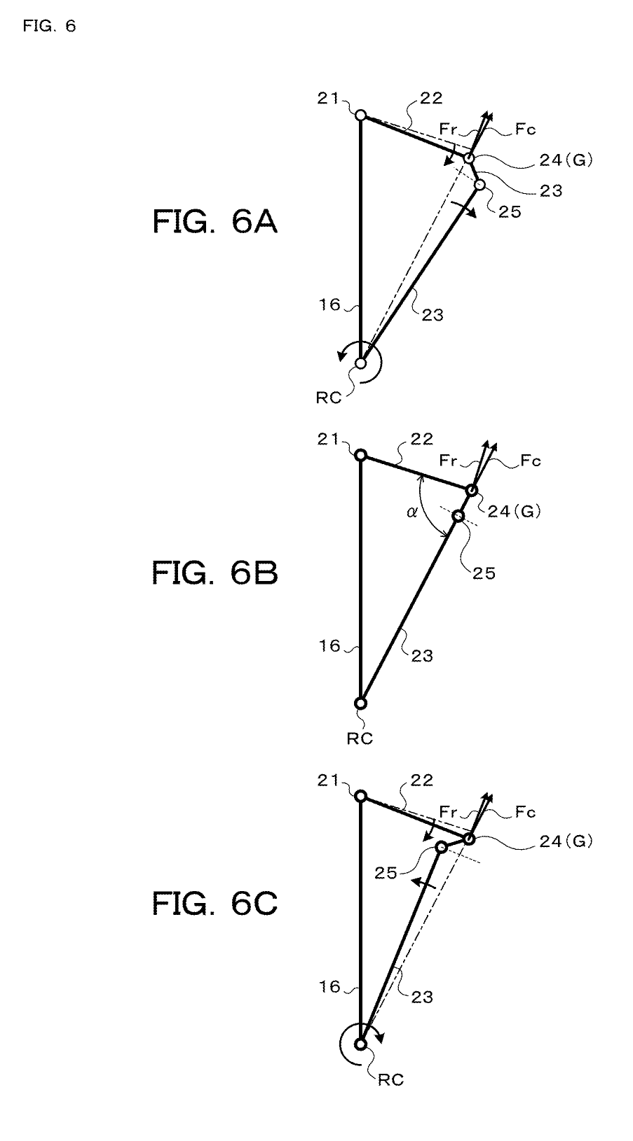

As discussed above, the first driven plate 16, the crank members 22, the inertial mass body 23, the first and second coupling shafts 21 and 24, and the guide portions 235 of the vibration damping device 20 substantially constitute a four-node rotary link mechanism, that is, a double lever mechanism, that meets the relationship L1+L2>L3+L4. Thus, when the first driven plate 16 is rotated in one direction (e.g. the counterclockwise direction in FIG. 5) about the center of rotation RC as illustrated in FIG. 5, each of the crank members 22 is rotated in the direction opposite the direction of rotation of the first driven plate 16 (e.g. the clockwise direction in FIGS. 5 and 6A) about the first coupling shaft 21 from the position in the equilibrium state (see the dash-and-dot line in FIG. 6A) because of the moment of inertia (difficulty of rotation) of the inertial mass body 23 as illustrated in FIGS. 5 and 6A. When motion of the crank members 22 is transferred to the inertial mass body 23 via the second coupling shafts 24 and the guide portions 235, further, the inertial mass body 23 is rotated in the direction opposite the direction of rotation of the first driven plate 16 (in the same direction as the crank members 22, i.e. the clockwise direction in the drawings) about the center of rotation RC.

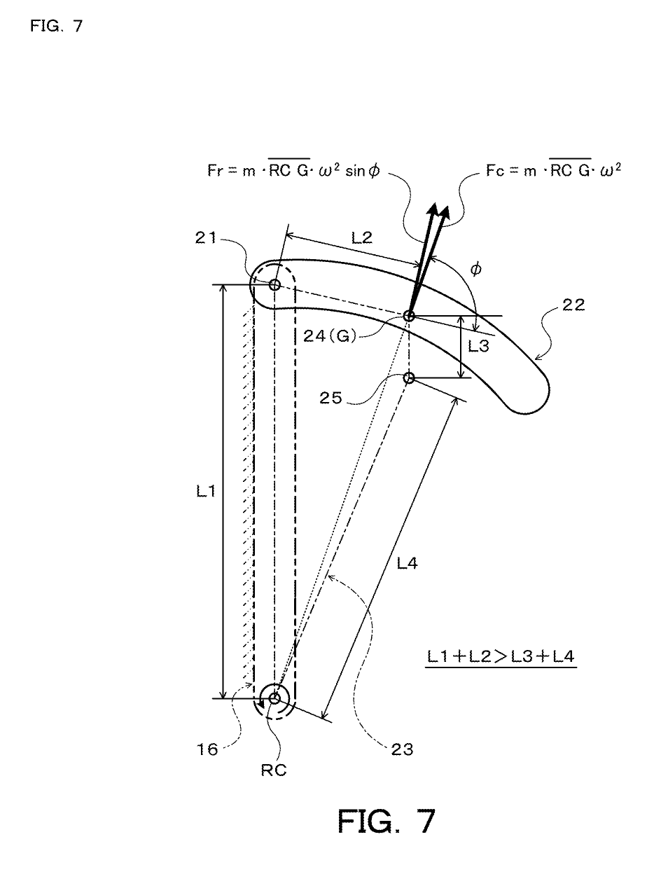

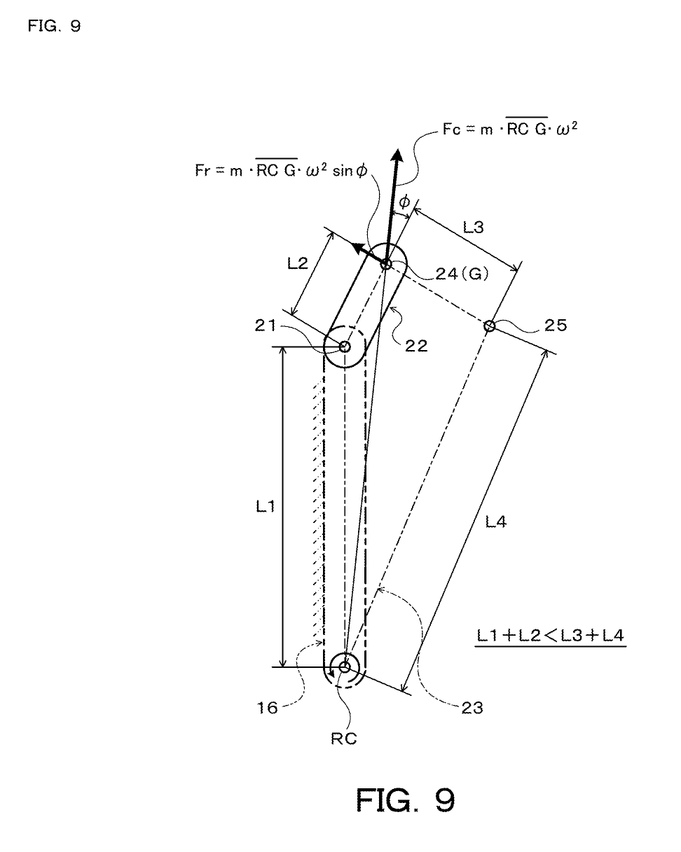

When the first driven plate 16 is rotated, in addition, a centrifugal force Fc acts on each of the crank members 22 (center of gravity G) as illustrated in FIG. 7. A component force (=Fc·sin ϕ) of the centrifugal force Fc in a direction that is orthogonal to the direction from the center of the first coupling shaft 21 toward the center of gravity G of the crank member 22 serves as a restoring force Fr that acts to return the crank member 22 (vibration damping device 20) to the position in the equilibrium state. The restoring force Fr which acts on each of the crank members 22 is transferred to the inertial mass body 23 via the second coupling shaft 24 and the guide portion 235. It should be noted, however, that “ϕ” is the angle formed by the direction of the centrifugal force Fc which acts on the crank member 22 and the direction from the center of the first coupling shaft 21 toward the center of gravity G of the crank member 22 (the center of the second coupling shaft 24). In FIG. 7, in addition, “m” denotes the weight of the crank member 22, and “w” denotes the rotational angular velocity of the first driven plate 16 (the same applies to FIG. 9).

The restoring force Fr which acts on each of the crank members 22 overcomes a force (moment of inertia) that acts to rotate the crank member 22 and the inertial mass body 23 in the rotational direction in which the crank member 22 and the inertial mass body 23 have been rotated so far, at a turn-back position (see the solid line in FIG. 6A) at which the crank member 22 has been rotated in one direction (the clockwise direction in FIG. 6A) about the first coupling shaft 21 from the position in the equilibrium state, that is, a turn-back position determined in accordance with the amplitude (vibration level) of vibration transferred from the engine EG to the first driven plate 16. Consequently, each of the crank members 22 is rotated in the direction opposite the direction in which the crank member 22 has been rotated so far about the first coupling shaft 21, and returned to the position in the equilibrium state illustrated in FIG. 6B from the turn-back position. In addition, the inertial mass body 23 is rotated in the direction opposite the direction in which the inertial mass body 23 has been rotated so far about the center of rotation RC in conjunction with each of the crank members 22, and returned to the position in the equilibrium state illustrated in FIG. 6B from one end of the swing range which is determined in accordance with the vibration angle (swing range) of the crank member 22 and which is centered on the position in the equilibrium state.

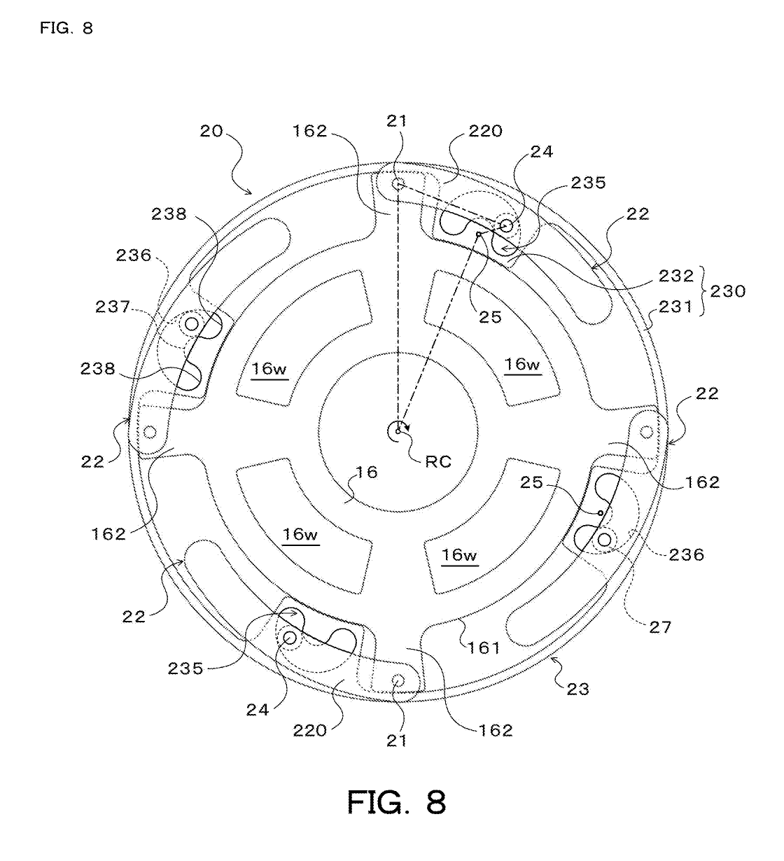

Further, when the first driven plate 16 is rotated in the other direction (e.g. the clockwise direction in FIG. 8) about the center of rotation RC by vibration from the engine EG transferred via the drive member 11 etc. as illustrated in FIG. 8, the crank member 22 is rotated in the same direction as the first driven plate 16 (e.g. the clockwise direction in FIGS. 6C and 8) about the first coupling shaft 21 from the position in the equilibrium state (see the dash-and-dot line in FIG. 6C) because of the moment of inertia (difficulty of rotation) of the inertial mass body 23 as illustrated in FIGS. 6C and 8. In this event, since the vibration damping device 20 is configured to meet the relationship L1+L2>L3+L4, the inertial mass body 23 is rotated in the direction opposite the directions of rotation of the first driven plate 16 and the crank members 22 (e.g. the counterclockwise direction in FIGS. 6C and 8) about the center of rotation RC of the first driven plate 16 as illustrated in FIGS. 6C and 8 with motion of the crank members 22 transferred to the inertial mass body 23 via the second coupling shafts 24 and the guide portions 235.

Also in this case, the centrifugal force Fc acts on each of the crank members 22 (center of gravity G), and a component force of the centrifugal force Fc that acts on each of the crank members 22, that is, the restoring force Fr, is transferred to the inertial mass body 23 via the second coupling shaft 24 and the guide portion 235. The restoring force Fr which acts on each of the crank members 22 overcomes a force (moment of inertia) that acts to rotate the crank member 22 and the inertial mass body 23 in the rotational direction in which the crank member 22 and the inertial mass body 23 have been rotated so far, at a turn-back position (see the solid line in FIG. 6C) at which the crank member 22 has been rotated in the one direction about the first coupling shaft 21 (the clockwise direction in FIG. 6C) from the position in the equilibrium state, that is, a turn-back position determined in accordance with the amplitude (vibration level) of vibration transferred from the engine EG to the driven member 15. Consequently, each of the crank members 22 is rotated in the direction opposite the direction in which the crank member 22 has been rotated so far about the first coupling shaft 21, and returned to the position in the equilibrium state illustrated in FIG. 6B from the turn-back position. In addition, the inertial mass body 23 is rotated in the direction opposite the direction in which the inertial mass body 23 has been rotated so far about the center of rotation RC in conjunction with each of the crank members 22, and returned to the position in the equilibrium state illustrated in FIG. 6B from the other end of the swing range which is determined in accordance with the vibration angle (swing range) of the crank member 22 and which is centered on the position in the equilibrium state.

In this way, when the first driven plate 16 is rotated in one direction, each of the crank members 22, which serves as a restoring force generation member, of the vibration damping device 20 makes swinging motion (reciprocal rotational motion) about the first coupling shaft 21 between the position in the equilibrium state and the turn-back position which is determined in accordance with the amplitude (vibration level) of vibration transferred from the engine EG to the first driven plate 16, and the inertial mass body 23 makes swinging motion (reciprocal rotational motion) in the direction opposite the direction of rotation of the first driven plate 16 about the center of rotation RC within the swing range which is determined in accordance with the vibration angle (swing range) of the crank member 22 and which is centered on the position in the equilibrium state. That is, while each of the crank members 22 makes motion of moving from the position in the equilibrium state to the turn-back position and returning from the turn-back position to the position in the equilibrium state twice, the inertial mass body 23 moves from the position in the equilibrium state to one end of the swing range, thereafter returns to the position in the equilibrium state, further moves to the other end of the swing range, and thereafter returns to the position in the equilibrium state. Consequently, it is possible to damp vibration of the first driven plate 16 by applying vibration that is opposite in phase to vibration transferred from the engine EG to the drive member 11 from the inertial mass body 23 which is swung to the first driven plate 16 via the second coupling shafts 24 and the crank members 22.

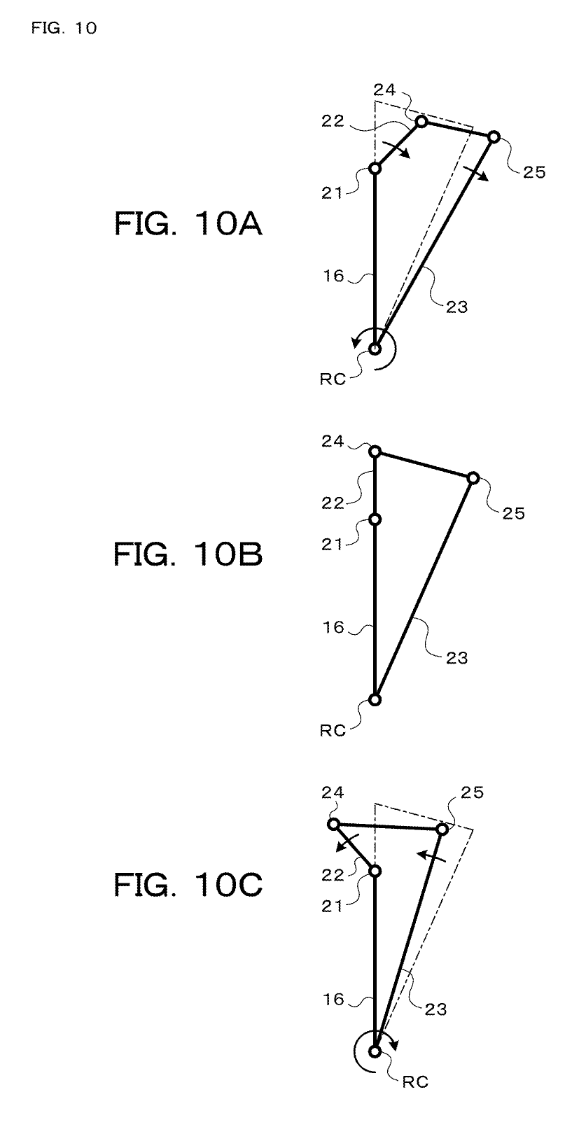

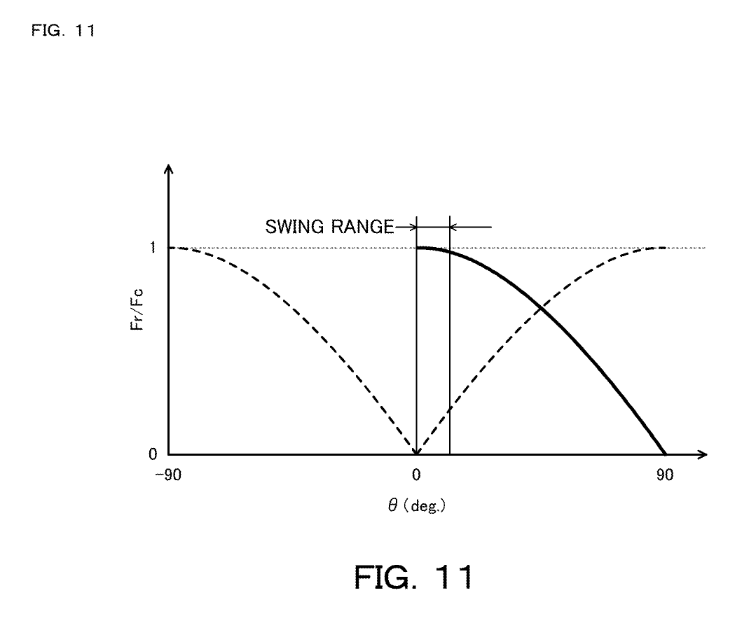

Here, in a vibration damping device that does not meet the relationship L1+L2>L3+L4, that is, a different vibration damping device (see FIG. 9) that meets the relationship L1+L2<L3+L4 as with the damper device described in Patent Document 1, the crank member 22 always makes swinging motion (reciprocal rotational motion) in the direction opposite the direction of rotation of the first driven plate 16 about the first coupling shaft 21 within the swing range which is centered on the position in the equilibrium state, as with the inertial mass body 23, as illustrated in FIGS. 10A, 10B, and 10C. Further, in the different vibration damping device, a component force of the centrifugal force that acts on the crank member 22 in a direction that is orthogonal to the direction from the center of the first coupling shaft 21 toward the center of gravity G of the crank member 22 becomes zero in the equilibrium state illustrated in FIG. 10B. That is, in the different vibration damping device, the restoring force Fr which acts on the crank member 22 which is swung within the swing range which is centered on the position in the equilibrium state becomes zero (minimum) at the position in the equilibrium state (at a vibration angle θ of 0° in FIG. 11) as indicated by the broken line in FIG. 11, and the ratio (Fr/Fc) of the restoring force Fr to the centrifugal force Fc is increased as the vibration angle θ becomes larger (as the crank member 22 approaches an end portion of the swing range).

In the vibration damping device 20 which meets the relationship L1+L2>L3+L4, in contrast, a component force of the centrifugal force that acts on the crank member 22 in a direction that is orthogonal to the direction from the center of the first coupling shaft 21 toward the center of gravity G of the crank member 22 in the equilibrium state illustrated in FIG. 6B becomes more than zero. That is, in the vibration damping device 20, the restoring force Fr which acts on the crank member 22 which is swung between the position in the equilibrium state and the turn-back position becomes maximum at the position in the equilibrium state (at a vibration angle θ of 0° in FIG. 11) as indicated by the solid line in FIG. 11, and reduced as the vibration angle θ becomes larger. In other words, while a restoring force does not act on each of the crank members 22 momentarily when the equilibrium state is established while the crank members 22 and the inertial mass body 23 are swung within their respective swing ranges in the different vibration damping device, a restoring force always acts on each of the crank members 22 while the crank members 22 and the inertial mass body 23 are swung within their respective swing ranges in the vibration damping device 20.

In addition, in the vibration damping device 20, as discussed above, while each of the crank members 22 makes motion of moving from the position in the equilibrium state to the turn-back position and returning from the turn-back position to the position in the equilibrium state twice, the inertial mass body 23 moves from the position in the equilibrium state to one end of the swing range, thereafter returns to the position in the equilibrium state, further moves to the other end of the swing range, and thereafter returns to the position in the equilibrium state. Thus, the vibration angle θ, that is, the swing range, of the crank member 22 about the first coupling shaft 21 which matches vibration transferred to the first driven plate 16 is small compared to the inertial mass body 23. That is, in the vibration damping device 20, motion of the second coupling shafts 24 and the inertial mass body 23 is similar to motion of two links that constitute a toggle mechanism, which significantly restricts swinging motion of the crank members 22 compared to the inertial mass body 23 as seen from FIGS. 6A, 6B, and 6C.

As a result, in the vibration damping device 20, as illustrated in FIG. 11, the swing range of the crank member 22 is a narrow range to a position at which the crank member 22 has been vibrated by a relatively small angle from the position in the equilibrium state (θ=0°). Thus, it is possible to increase the restoring force Fr for the same centrifugal force Fc which acts on the crank member 22 (ratio Fr/Fc) compared to a case where a component force of the centrifugal force Fc that acts on the crank member 22 in a direction that is orthogonal to the direction from the center of the first coupling shaft 21 toward the center of gravity G of the crank member 22 becomes zero in the equilibrium state (the different vibration damping device). Specifically, in the vibration damping device 20, the direction of the restoring force Fr (=Fc·sin ϕ) which acts on the center of gravity G of the crank member 22 can be made closer to the direction of the centrifugal force Fc by approximating the angle θ indicated in FIGS. 7 to 90°. In a state that is close to the equilibrium state illustrated in FIG. 7, in particular, the direction of the restoring force Fr is very close to the direction of the centrifugal force Fc (the angle θ is closer to 90°). The fact that a larger restoring force Fr may be applied to the crank member 22 (and the inertial mass body 23) means that the vibration damping device 20 has high torsional rigidity. Thus, with the vibration damping device 20, it is possible to increase an equivalent rigidity K while suppressing an increase in weight of the crank member 22.

In addition, while the inertial mass body 23 is swung about the center of rotation RC within the swing range which is centered on the position in the equilibrium state, the crank member 22 is swung about the first coupling shaft 21 between the position in the equilibrium state and the turn-back position at which the crank member 22 has been rotated in one direction about the first coupling shaft 21 from the position in the equilibrium state. That is, in the vibration damping device 20, as illustrated in FIGS. 6A, 6B, and 6C, while the inertial mass body 23 is always rotated in the direction opposite the direction (in the phase opposite the phase) of rotation of the first driven plate 16 about the center of rotation RC, the crank member 22 is not only rotated in the direction opposite the direction (in the phase opposite the phase) of rotation of the first driven plate 16, but also rotated in the same direction as (in the same phase as) the first driven plate 16, about the first coupling shaft 21. Consequently, the effect of the weight of the crank member 22 on an equivalent mass M of the vibration damping device 20 can be made very small.

Thus, with the vibration damping device 20, it is possible to further improve the degree of freedom in setting of the equivalent rigidity K and the equivalent mass M, that is, the vibration order q=(KIM), which allows improving the vibration damping performance significantly well while suppressing an increase in weight or size of the crank member 22 and hence the entire device. In the vibration damping device which meets the relationship L1+L2<L3+L4 such as the damper device described in Patent Document 1, as illustrated in FIGS. 10A, 10B, and 10C, the crank member 22 is always rotated in the direction opposite the direction of rotation of the first driven plate 16 about the first coupling shaft 21 as with the inertial mass body 23. Thus, with the damper device described in Patent Document 1, the weight of the crank member 22 greatly affects both the equivalent rigidity K and the equivalent mass M, and thus it is not easy to improve the degree of freedom in setting of the vibration order q as with the vibration damping device 20 according to the present embodiment.

In addition, an analysis conducted by the inventors has revealed that the equivalent rigidity K of the vibration damping device 20 is inversely proportional to the square value of a ratio ρ=L3/(L3+L4) of the interaxial distance L3 to the sum of the interaxial distances L3 and L4. Thus, it is possible to increase the equivalent rigidity K while suppressing an increase in weight of the crank member 22 by making the interaxial distance L3 between the second coupling shaft 24 and the virtual axis 25 shorter than the interaxial distance L1 between the center of rotation RC and the first coupling shaft 21, the interaxial distance L2 between the first coupling shaft 21 and the second coupling shaft 24, and the interaxial distance L4 between the virtual axis 25 and the center of rotation RC as discussed above. Further, the vibration angle of the crank member 22 about the first coupling shaft 21 can be reduced by making the interaxial distance L3 shorter. Consequently, it is possible to further reduce the effect of the weight of the crank member 22 on the equivalent mass M, and to make the entire device compact by causing an end portion of the crank member 22 on the side away from the first coupling shaft 21 to be moved toward the center of rotation RC (or reducing the amount of projection toward the radially outer side as much as possible). Additionally, the cycle of swinging motion of the crank members 22 and the mass body can be made constant (the isochronism of the swinging motion can be kept) by making the interaxial distance L3 shorter.

In the vibration damping device 20, further, the interaxial distance L1 between the center of rotation RC and the first coupling shaft 21 is determined to be longer than the interaxial distances L2, L3, and L4. Consequently, the center of gravity G (second coupling shaft 24) of the crank member 22 can be positioned on the radially outer side with the crank member 22 spaced away from the center of rotation RC of the first driven plate 16. Thus, it is possible to secure a sufficient space for arrangement of the springs SP of the damper device 10, and to increase a component force of the centrifugal force Fc that acts on the crank member 22, that is, the restoring force Fr, without increasing the weight of the crank member 22.

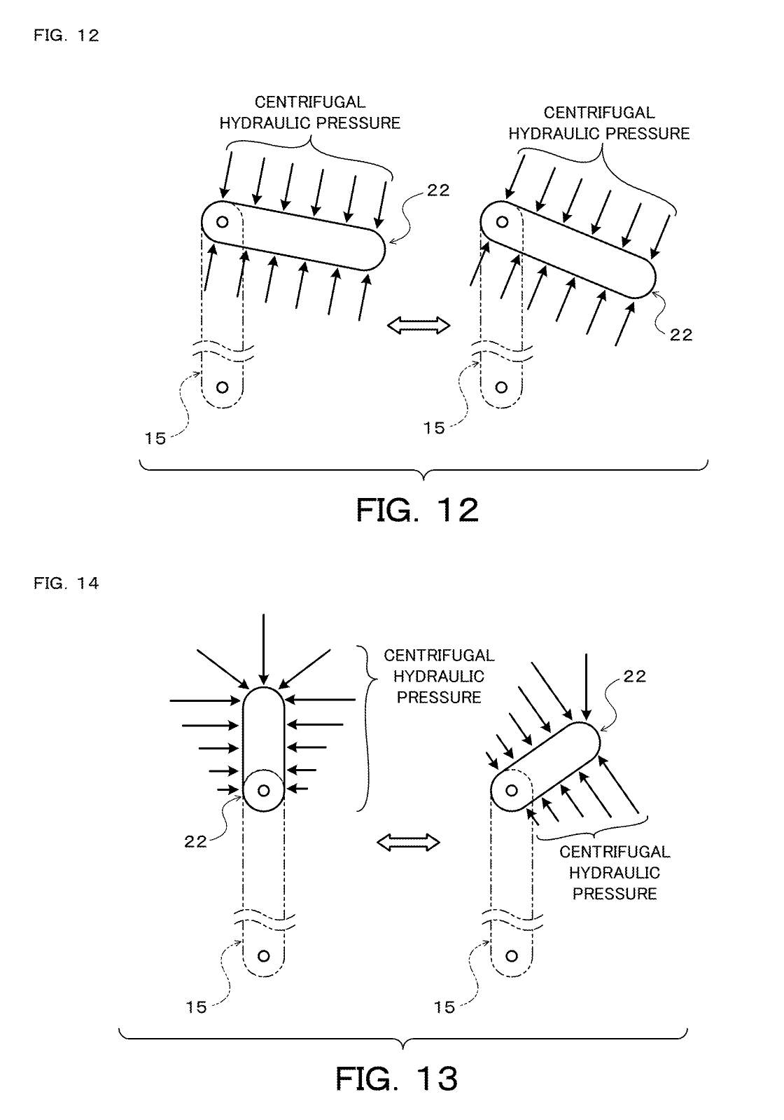

In addition, by making the interaxial distance L1 the longest while meeting the relationship L1+L2>L3+L4, the crank member 22 can be disposed along a circumference that passes through the center of the first coupling shaft 21 and that is centered on the center of rotation RC, and the vibration angle of the crank member 22 about the first coupling shaft 21 can be reduced. Consequently, as seen from FIG. 12, it is possible to reduce the effect, on the restoring force Fr, of a force due to a centrifugal hydraulic pressure that acts on the crank member 22 in the fluid transmission chamber 9 which is filled with hydraulic oil, and to reduce fluctuations in force due to the centrifugal hydraulic pressure which is caused when the crank member 22 is swung, compared to the vibration damping device (see FIG. 13) which meets the relationship L1+L2<L3+L4 such as the damper device described in Patent Document 1.

Additionally, it is possible to reduce the effect, on the restoring force Fr, of the force due to the centrifugal hydraulic pressure which acts on the crank member 22 well by constituting the crank member 22 using two plate members 220 that have an arcuate planar shape.

By configuring the vibration damping device 20 so as to meet L1>L4>L2>L3, further, practically good equivalent rigidity K can be secured, and the effect of the weight of the crank member 22 on the equivalent mass M can be reduced to be practically ignorable. As a result, it is possible to damp vibration significantly well by easily causing the vibration order q of the vibration damping device 20 to coincide with (approximate) the order of vibration to be damped. The maximum vibration angle (swing limit) of each of the crank members 22 and the maximum swing range of the inertial mass body 23 are determined from the interaxial distances L1, L2, L3, and L4. Thus, the interaxial distances L1, L2, L3, and L4 of the vibration damping device 20 are preferably determined in consideration of the amplitude (vibration level) of vibration transferred to the driven member 15 so that the vibration damping device 20 do not fail to damp vibration transferred to the driven member 15.

In addition, the vibration damping device 20 according to the present embodiment is configured to meet 60° a 120°, more preferably 70° a 90°, when the angle formed by the direction from the center of the first coupling shaft 21 toward the center of the second coupling shaft 24 and the direction from the center of the second coupling shaft 24 toward the center of rotation RC of the first driven plate 16 in the equilibrium state in which the center of the second coupling shaft 24, the center of the virtual axis 25, and the center of rotation RC are positioned on one line is defined as “a”. Consequently, the inertial mass body 23 can be prevented from being swung greatly to one side of the swing range to reach the swing limit (dead center) on the one side and being swung slightly to the other side when the rotational speed of the first driven plate 16 is low. As a result, it is possible to further improve the vibration damping performance of the vibration damping device 20 by swinging the inertial mass body 23 symmetrically with respect to the position in the equilibrium state (see FIG. 6B) since the time when the rotational speed of the first driven plate 16 is relatively low.

In the vibration damping device 20, a four-node rotary link mechanism can be constituted without using a link coupled to both the crank members 22 and the inertial mass body 23, that is, a connecting rod in a common four-node rotary link mechanism. Thus, in the vibration damping device 20, it is not necessary to secure the strength or the durability of the connecting rod by increasing the thickness or the weight, and thus it is possible to suppress an increase in weight or size of the entire device well. In the vibration damping device 20 which does not include a connecting rod, additionally, the vibration damping performance can be secured well by suppressing a reduction of the restoring force Fr that is attributable to movement of the center of gravity G of the crank member 22 toward the center of rotation RC due to an increase in weight (moment of inertia) of the connecting rod. In the vibration damping device which includes a connecting rod, meanwhile, it is necessary to provide a bearing such as a sliding bearing or a rolling bearing at both ends of the connecting rod. Thus, the degree of freedom in setting of the length of the connecting rod is lowered, which may make it difficult to improve the vibration damping performance of the damper. In contrast, it is not necessary to provide a bearing such as a sliding bearing or a rolling bearing on the virtual axis 25 of the vibration damping device 20, and thus it is possible to easily shorten the interaxial distance L3 between the second coupling shaft 24 and the virtual axis 25 by improving the degree of freedom in setting of the interaxial distance L3, that is, the length of the connecting rod in the common four-node rotary link mechanism. Thus, the vibration damping performance of the vibration damping device 20 can be improved easily by adjusting the interaxial distance L3. Further, a link (connecting rod) coupled to both the crank member 22 and the inertial mass body 23 is not required, and thus a component force of the centrifugal force that acts on the crank member 22 is not used to return the link which is coupled to both the crank member 22 and the inertial mass body 23 to the position in the equilibrium state. Thus, the vibration damping performance of the vibration damping device 20 can be improved while suppressing an increase in weight of the crank member 22. In addition, it is possible to secure the vibration damping performance well by smoothly guiding the second coupling shaft 24 using the guide portion 235 by swinging the second coupling shaft 24 about the virtual axis 25 so as to keep the interaxial distance between the first coupling shaft 21 and the second coupling shaft 24 and the interaxial distance between the virtual axis 25 and the second coupling shaft 24 constant. As a result, with the vibration damping device 20, it is possible to further improve the vibration damping performance while suppressing an increase in weight or size of the entire device.

In the vibration damping device 20, in addition, the guide portion 235 of the inertial mass body 23 includes the guide surface 236 in a recessed curved surface shape which has a constant radius of curvature, and the second coupling shaft 24 is moved along the guide surface 236 along with rotation of the first driven plate 16. Consequently, it is possible to swing the second coupling shaft 24 about the first coupling shaft 21 while keeping the interaxial distance L2 between the first coupling shaft 21 and the second coupling shaft 24 constant, and to swing the second coupling shaft 24 about the virtual axis 25 while keeping the interaxial distance L3 between the virtual axis 25 and the second coupling shaft 24 constant, along with rotation of the first driven plate 16. By forming the guide surface 236 in a recessed curved surface shape with a constant curvature, it is possible to smoothly roll the outer ring 27 on the guide surface 236 while suppressing occurrence of a skid or a bounce, and the second coupling shaft 24 can be guided smoothly by the guide portion 235 to stabilize torque fluctuations, which can secure the vibration damping performance well. It should be noted, however, that the guide surface 236 should not be a recessed circular columnar surface that has a constant radius of curvature, and the guide surface 236 may be a recessed curved surface formed such that the radius of curvature is varied stepwise or gradually as long as the second coupling shaft 24 is moved as discussed above.

Further, the vibration damping device 20 includes the plurality of rollers (rolling bodies) 26 and the outer ring 27 which is rotatably supported by the second coupling shaft 24 via the plurality of rollers 26 and which rolls on the guide surface 236. The plurality of rollers 26, the outer ring 27, and the second coupling shaft 24 constitute a rolling bearing. Consequently, a loss due to friction around the second coupling shaft 24 can be reduced even if a tensile load based on a centrifugal force that acts on the second coupling shaft 24 has become large. As a result, it is possible to improve the vibration damping performance well by causing the vibration order q of the vibration damping device 20 to approximate the order of target vibration to be damped.

The analysis conducted by the inventors has revealed that a tensile load based on a centrifugal force that acts on the second coupling shaft 24 of the vibration damping device 20 is relatively large, and that adopting a rolling bearing structure such as that discussed above as the support structure for the second coupling shaft 24 is significantly useful in obtaining a desired vibration order q by reducing a loss due to friction around the second coupling shaft 24. The analysis conducted by the inventors has additionally revealed that a tensile load based on a centrifugal force that acts on the first coupling shaft 21 is sufficiently small compared to a tensile load based on a centrifugal force that acts on the second coupling shaft 24. Thus, a sliding bearing portion provided to the first driven plate 16 and the crank members 22 such as those discussed above can be adopted as the support structure for the first coupling shaft 21.

Consequently, it is possible to reduce the size and the weight of the entire device by simplifying the configuration around the first coupling shaft 21.

In addition, the guide portion 235 of the inertial mass body 23 includes the support surface 237 in a projecting curved surface shape which is provided on the inner side in the radial direction of the first driven plate 16 and the inertial mass body 23 with respect to the guide surface 236 to face the guide surface 236. Consequently, it is possible to swing the crank members 22 and the inertial mass body 23 more adequately by supporting the second coupling shafts 24 using the support surfaces 237 when the rotational speed of the first driven plate 16 (driven member 15) is low or when the first driven plate 16 (driven member 15) is stationary.

Further, by forming the inertial mass body 23 with the guide portions 235 and having the second coupling shafts 24 supported by the crank members 22, it is possible to suppress an increase in weight and size of the entire device while securing the required weight (moment of inertia) of the crank member 22 and the inertial mass body 23. It should be noted, however, that the guide portions 235 may be formed in the crank members 22, and that the second coupling shafts 24 may be supported by the inertial mass body 23.

By using the annular inertial mass body 23 as in the embodiment described above, in addition, it is possible to eliminate the effect of a centrifugal force (and a centrifugal liquid pressure) that acts on the inertial mass body 23 (annular members 230) on swinging motion of the inertial mass body 23, and to increase the moment of inertia of the inertial mass body 23 while suppressing an increase in weight of the inertial mass body 23. By disposing the annular inertial mass body 23 on the radially outer side with respect to the outer peripheral surface 161 of the first driven plate 16 which extends between the projecting support portions 162 which are adjacent to each other, the moment of inertia of the inertial mass body 23 can be increased while suppressing an increase in weight of the inertial mass body 23.

In the embodiment described above, further, the crank members 22 each include two plate members 220 that face each other in the axial direction of the first driven plate 16, and the inertial mass body 23 includes two annular members 230 disposed between the two plate members 220 in the axial direction so as to face each other. Additionally, the first driven plate 16 is a single plate-like member disposed between the two annular members 230 in the axial direction. Consequently, it is possible to further improve the vibration damping performance by disposing the crank members 22 and the inertial mass body 23 on both sides of the single first driven plate 16 in a well-balanced manner while suppressing an increase in axial length of the vibration damping device 20 by omitting a connecting rod in a common four-node rotary link mechanism.

In addition, the analysis conducted by the inventors has revealed that, in the vibration damping device 20, the outer ring 27 is more likely to skid with respect to the guide surface 236 as a contact portion between the outer ring 27 and the guide surface 236 becomes closer to the center of rotation RC. Thus, the vibration damping device 20 may be designed such that the center of the second coupling shaft 24 is not positioned closer to the center of rotation RC than a line (see the broken line in FIGS. 6A, 6B, and 6C) that passes through the virtual axis 25 and that is orthogonal to a line segment that connects between the center of rotation RC and the virtual axis 25 when the second coupling shaft 24 swings about the virtual axis 25 as guided by the guide portion 235. That is, the vibration damping device 20 may be designed such that the second coupling shaft 24 is turned about the virtual axis 25 by a vibration angle that is equal to or less than 90° to both sides from the equilibrium state with respect to the inertial mass body 23. Consequently, the second coupling shaft 24 can be moved smoothly by causing the outer ring 27 to roll without skidding on the guide surface 236 over the entire swing range of the second coupling shaft 24, and thus it is possible to secure the vibration damping performance well.

It has been revealed that, in the vibration damping device 20 discussed above, there occurs a deviation between an order (hereinafter referred to as a “target order”) qtag of vibration to be originally intended to be damped by the vibration damping device 20 and the order (hereinafter referred to as an “effective order”) of vibration to be actually damped by the vibration damping device 20 when the vibration angle of the inertial mass body 23 becomes large. In the vibration damping device 20, in addition, when a state in which the inertial mass body 23 has been rotated by a certain initial angle (an angle corresponding to the vibration angle of the inertial mass body 23 about the center of rotation) about the center of rotation from the position in the equilibrium state is defined as an initial state, the inertial mass body 23 etc. are swung at a frequency that matches the initial angle in the case where torque that does not contain a vibration component is applied to the first driven plate 16 to rotate the first driven plate 16 at a constant rotational speed.

In the light of the above, in order to suppress the order deviation discussed above by adjusting the ratio ρ=L3/(L3+L4) of the interaxial distance L3 to the sum of the interaxial distances L3 and L4 discussed above, the inventors prepared a plurality of models of the vibration damping device 20 that had different ratios ρ, and performed a simulation for each of the models in which torque that did not contain a vibration component was applied to the first driven plate 16 for each of a plurality of initial angles (vibration angles) to rotate the first driven plate 16 at a constant rotational speed (e.g. 1000 rpm). All the plurality of models used in the simulation were prepared to damp vibration with a target order qtag=2 of four-cylinder engines, and met the relationship Lg=L2. By performing such a simulation, the inventors calculated an effective order for each vibration angle (initial angle) of the inertial mass body 23 on the basis of a difference (amount of deviation) between the frequency of swinging motion of the inertial mass body 23 and a theoretical value (33.3 Hz with a target order qtag=2 and at a rotational speed of 1000 rpm) for each of the models (ratio ρ).

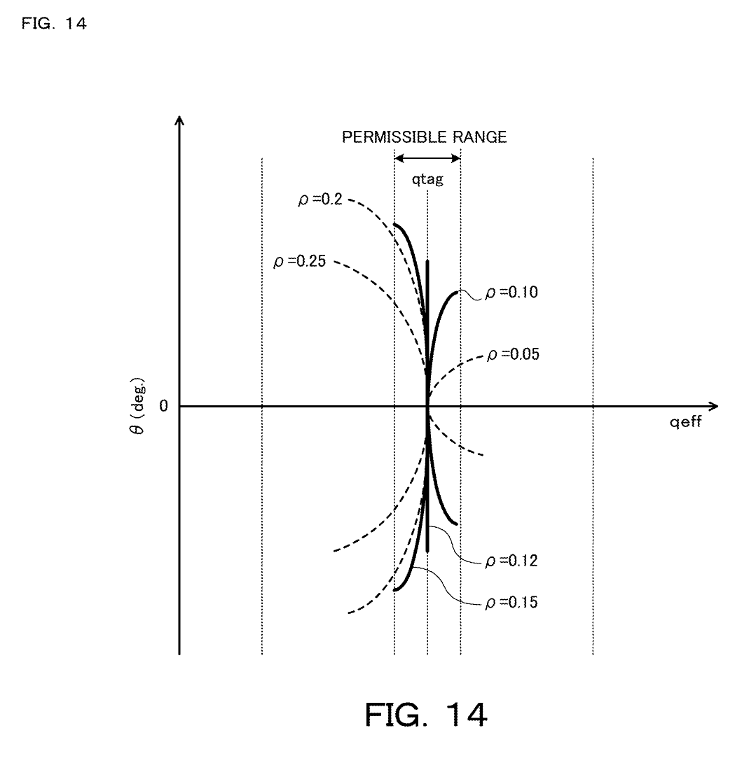

FIG. 14 illustrates the results of analyzing the relationship between a vibration angle θ of the inertial mass body 23 about the center of rotation RC and an effective order qeff for the plurality of models of the vibration damping device 20 (ratio ρ). As indicated in the drawing, for a model with a ratio ρ=0.05, an order deviation occurred when the vibration angle θ of the inertial mass body 23 about the center of rotation RC was significantly small, and the amount of deviation of the effective order qeff from the target order qtag went out of the permissible range before the vibration angle θ reached the maximum vibration angle. Also for a model with a ratio ρ=0.25, similarly, an order deviation occurred when the vibration angle θ of the inertial mass body 23 about the center of rotation RC was relatively small, and the amount of deviation of the effective order qeff from the target order qtag went out of the permissible range before the vibration angle θ reached the maximum vibration angle.

For a model with a ratio ρ=0.20, in contrast, there occurred an order deviation when the vibration angle θ of the inertial mass body 23 about the center of rotation RC became large, but the amount of deviation of the effective order qeff from the target order qtag was included in the permissible range over a relatively wide range of the swing range (between the maximum vibration angles). For models with a ratio ρ=0.10 and 0.15, in addition, the amount of deviation of the effective order qeff from the target order qtag was included in the permissible range over the entire range of the vibration angle θ. For a model with a ratio ρ=0.12, further, the effective order qeff generally coincided with the target order qtag over the entire range of the vibration angle θ. Thus, it is understood that, by configuring the vibration damping device 20 so as to meet the relationship 0.1≤ρ=L3/(L3+L4)≤0.2, more preferably 0.1≤ρ≤0.15, the vibration damping performance of the vibration damping device 20 may be improved better by reducing variations in the effective order qeff (order deviation) at the time when the vibration angle θ of the inertial mass body 23 about the center of rotation RC is large.

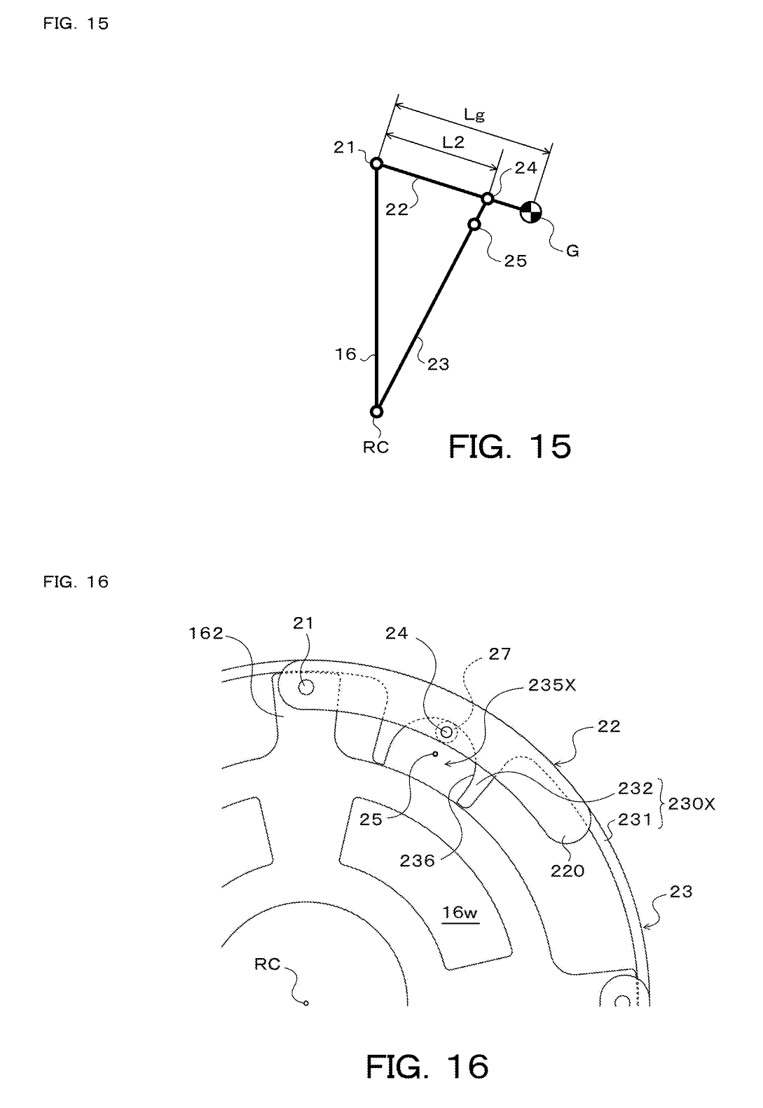

By causing the length Lg from the center of the first coupling shaft 21 to the center of gravity G of the crank member 22 to coincide with the interaxial distance L2 between the first coupling shaft 21 and the second coupling shaft 24 as in the vibration damping device 20, it is possible to reduce the load which acts on the support portion (bearing portion) of the first coupling shaft 21. It should be noted, however, that it is not necessary that the length Lg and the interaxial distance L2 should coincide with each other. That is, the vibration damping device 20 may be configured to meet the relationship Lg>L2 as illustrated in FIG. 15. Consequently, although the load which acts on the support portion (bearing portion) of the first coupling shaft 21 is increased compared to a case where the relationship Lg=L2 is met, it is possible to further increase the restoring force Fr which acts on the crank member 22 using leverage. In the example illustrated in FIG. 15, in addition, the center of gravity G of the crank member 22 is positioned on a line that passes through the centers of the first and second coupling shafts 21 and 24. However, it is not necessary that the center of gravity G should be positioned on the line which passes through the centers of the first and second coupling shafts 21 and 24. It should be understood that, even in the case where the center of the second coupling shaft 24 and the center of gravity G of the crank member 22 do not extend coaxially with each other, a component force of the centrifugal force that acts on the crank member 22 in a direction that is orthogonal to the direction from the center of the first coupling shaft 21 toward the center of the second coupling shaft 24 also becomes larger than zero if the restoring force Fr which acts on the center of gravity G of the crank member 22 in the equilibrium state becomes larger than zero.

In addition, the guide portion 235 includes the support surface 237 in a projecting curved surface shape which faces the guide surface 236 and the stopper surfaces 238. As illustrated in FIG. 16, however, the support surface 237 and the stopper surfaces 238 may be omitted. A guide portion 235X formed in the projecting portion 232 of an annular member 230X illustrated in FIG. 16 is a generally semi-circular notch that has the guide surface 236 in a recessed curved surface shape (recessed circular columnar surface shape) that has a constant radius of curvature. Consequently, it is possible to simplify the structure of the guide portion 235X which guides the second coupling shaft 24, and hence the structure of the vibration damping device 20. It should be understood that a guide portion that is similar to the guide portion 235X may be formed in the plate members 220 of the crank member 22.

In the embodiment described above, further, the annular inertial mass body 23 may be configured to be rotatably supported (aligned) by the first driven plate 16. Consequently, it is possible to smoothly swing the inertial mass body 23 about the center of rotation RC of the first driven plate 16 when the crank members 22 are swung. In this case, a spacer that is in sliding contact with the outer peripheral surfaces of the projecting support portions 162 of the first driven plate 16 may be disposed (fixed) between the main bodies 231 of the two annular members 230 in the axial direction, and a spacer that is in sliding contact with the outer peripheral surface 161 of the first driven plate 16 may be disposed (fixed) between the projecting portions 232 of the two annular members 230 in the axial direction.

In the vibration damping device 20, in addition, the inertial mass body 23 which is annular may be replaced with a plurality of (e.g. four) mass bodies that have the same specifications (such as dimensions and weight) as each other. In this case, the mass bodies may be constituted from metal plates that have an arcuate planar shape, for example, and that are coupled to the first driven plate 16 via the crank member 22 (two plate members 220), the second coupling shaft 24, and the guide portion 235 so as to be arranged at intervals (equal intervals) in the circumferential direction in the equilibrium state and swing about the center of rotation RC. In this case, further, a guide portion that guides each of the mass bodies so as to swing about the center of rotation RC while receiving a centrifugal force (centrifugal hydraulic pressure) that acts on the mass body may be provided at the outer peripheral portion of the first driven plate 16. Also with the vibration damping device 20 which includes such a plurality of mass bodies, it is possible to improve the degree of freedom in setting of the vibration order q, which allows further improving the vibration damping performance while suppressing an increase in weight or size of the crank member 22 and hence the entire device.

Further, the vibration damping device 20 may be configured to meet L1+L2<L3+L4 (see FIGS. 9, 10A, 10B, and 10C), although the restoring force Fr which acts on the crank member 22 is reduced. Consequently, it is possible to swing the second and third links stably and smoothly by eliminating a change point in the four-node rotary link mechanism. In this case, the interaxial distance L2 is preferably shorter than the interaxial distances L1, L3, and L4. In the case where such a relationship is met, the first driven plate 16, the crank members 22, the inertial mass body 23, the first and second coupling shafts 21 and 24, and the guide portions 235 substantially constitute a lever crank mechanism in which the first driven plate 16 (rotary element) serves as a fixed node and swinging motion of the crank members 22 is converted into swinging motion of the inertial mass body 23. Consequently, it is possible to further increase a moment about the center of rotation RC that acts on the inertial mass body 23 when the crank members 22 have started to swing with respect to the first driven plate 16 (rotary element) from the position in the equilibrium state, and to further increase a restoring force that acts on the inertial mass body 23 when the crank members 22 have reached one end of the swing range.

In the embodiment described above, in addition, the first driven plate 16 which is a rotary element of the damper device 10 itself serves as the first link of the vibration damping device 20. However, the present disclosure is not limited thereto. That is, the vibration damping device 20 may include a dedicated support member (first link) that constitutes a turning pair with the crank member 22 by swingably supporting the crank member 22 and that constitutes a turning pair with the inertial mass body 23. That is, the crank member 22 may be coupled to a rotary element indirectly via a dedicated support member that serves as the first link. In this case, it is only necessary that the support member of the vibration damping device 20 should be coupled so as to rotate coaxially and together with a rotary element, such as the drive member 11, the intermediate member 12, or the first driven plate 16 of the damper device 10, for example, vibration of which is to be damped. Also with the thus configured vibration damping device 20, it is possible to damp vibration of the rotary element well.

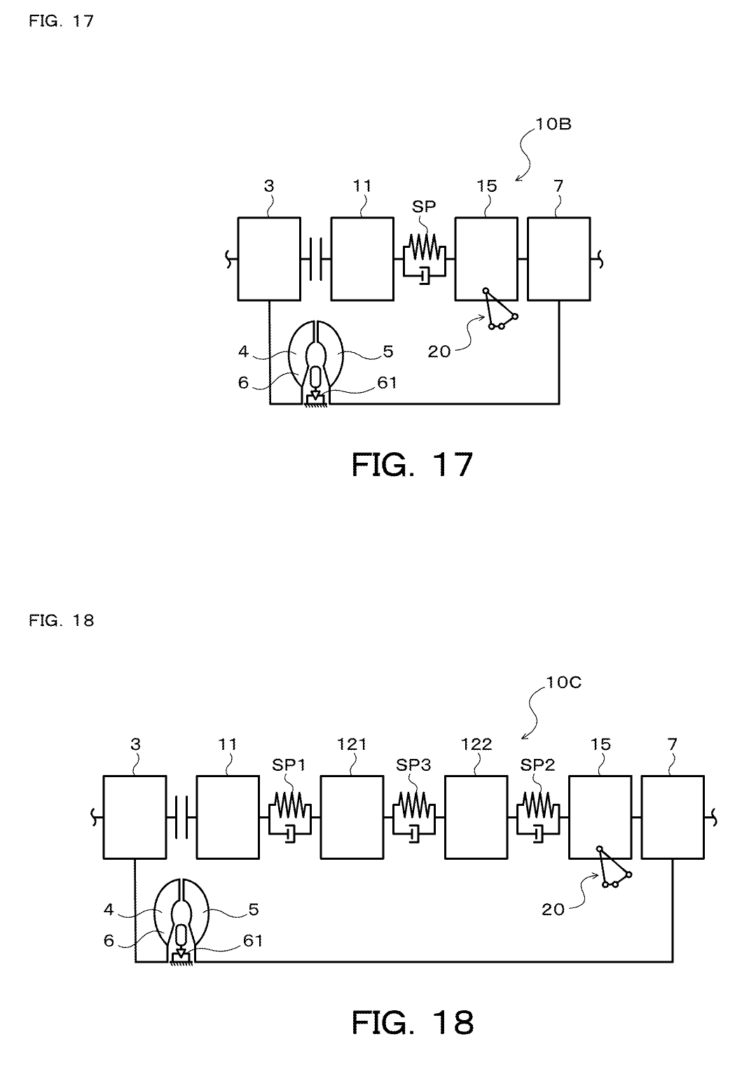

The vibration damping device 20 may be coupled to the drive member (input element) 11 of the damper device 10, or may be coupled to the intermediate member 12. In addition, the vibration damping device 20 may be applied to a damper device 10B illustrated in FIG. 17. The damper device 10B of FIG. 17 corresponds to the damper device 10 from which the intermediate member 12 has been omitted, and includes the drive member (input element) 11 and the driven member 15 (output element) as rotary elements, and also includes a spring SP disposed between the drive member 11 and the driven member 15 as a torque transfer element. In this case, the vibration damping device 20 may be coupled to the driven member 15 of the damper device 10B as illustrated in the drawing, or may be coupled to the drive member 11.

Further, the vibration damping device 20 may be applied to a damper device 10C illustrated in FIG. 18. The damper device 10C of FIG. 18 includes the drive member (input element) 11, a first intermediate member (first intermediate element) 121, a second intermediate member (second intermediate element) 122, and the driven member (output element) 15 as rotary elements, and also includes a first spring SP1 disposed between the drive member 11 and the first intermediate member 121, a second spring SP2 disposed between the second intermediate member 122 and the driven member 15, and a third spring SP3 disposed between the first intermediate member 121 and the second intermediate member 122 as torque transfer elements. In this case, the vibration damping device 20 may be coupled to the driven member 15 of the damper device 10C as illustrated in the drawing, or may be coupled to the drive member 11, the first intermediate member 121, or the second intermediate member 122. In any case, by coupling the vibration damping device 20 to a rotary element of the damper device 10, 10B, or 10C, it is possible to damp vibration significantly well using both the damper device 10 to 10C and the vibration damping device 20 while suppressing an increase in weight of the damper device 10 to 10C.

As has been described above, the present disclosure provides a vibration damping device (20) that damps vibration of a rotary element (15, 16), including: a support member (16) that rotates about a center of rotation (RC) of the rotary element (15, 16) together with the rotary element (15, 16); a restoring force generation member (22) rotatably coupled to the support member (16) via a first coupling shaft (21); an inertial mass body (23) that is rotatable about the center of rotation (RC); a second coupling shaft (24) that is supported by one of the restoring force generation member and the inertial mass body (22, 23) and that couples the restoring force generation member and the inertial mass body (22, 23) so that the restoring force generation member and the inertial mass body are rotatable relative to each other; and a guide portion (235) that is formed in the other of the restoring force generation member and the inertial mass body (22, 23) and that guides the second coupling shaft (24), along with rotation of the support member (16), such that the second coupling shaft (24) swings about the first coupling shaft (21) while keeping an interaxial distance (L2) between the first coupling shaft (21) and the second coupling shaft (24) constant, and such that the second coupling shaft (24) swings about a virtual axis (25), a relative position of which with respect to the inertial mass body (23) is determined to be invariable, while keeping an interaxial distance (L3) between the virtual axis (25) and the second coupling shaft (24) constant.

In the vibration damping device, when the support member (rotary element) is rotated in one direction, the second coupling shaft is moved in conjunction with the restoring force generation member while being guided by the guide portion to make swinging motion (reciprocal rotational motion) about the first coupling shaft while keeping the interaxial distance between the first coupling shaft and the second coupling shaft constant, and to make swinging motion (reciprocal rotational motion) about the virtual axis, the relative position of which with respect to the inertial mass body is invariable, while keeping the interaxial distance between the virtual axis and the second coupling shaft constant. That is, the restoring force generation member makes swinging motion about the first coupling shaft in accordance with movement of the second coupling shaft, and the virtual axis and the inertial mass body make swinging motion about the second coupling shaft which makes movement, and make swinging motion (reciprocal rotational motion) about the center of rotation of the rotary element (support member). As a result, the support member, the restoring force generation member, the inertial mass body, the first and second coupling shafts, and the guide portion substantially constitute a four-node rotary link mechanism in which the support member (rotary element) serves as a fixed node. Thus, it is possible to damp vibration of the rotary element by applying vibration that is opposite in phase to vibration of the rotary element from the inertial mass body to the rotary element, which rotates together with the support member, via the guide portion, the second coupling shaft, and the restoring force generation member along with rotation of the support member (rotary element).

In the vibration damping device, a four-node rotary link mechanism can be constituted without using a link coupled to both the restoring force generation member and the inertial mass body, that is, a connecting member in a common four-node rotary link mechanism. Thus, it is possible to suppress an increase in weight or size of the entire vibration damping device. In addition, it is not necessary to provide a bearing such as a sliding bearing or a rolling bearing on the virtual axis, and thus the degree of freedom in setting of the interaxial distance between the second coupling shaft and the virtual axis, that is, the length of a connecting member in a common four-node rotary link mechanism. Thus, it is possible to easily improve the vibration damping performance of the vibration damping device by adjusting the interaxial distance. Further, a link coupled to both the restoring force generation member and the inertial mass body is not required, and thus a component force of the centrifugal force that acts on the restoring force generation member is not used to return the link which is coupled to both the restoring force generation member and the inertial mass body to its position in the equilibrium state. Thus, the vibration damping performance of the vibration damping device can be improved while suppressing an increase in weight of the restoring force generation member. In addition, it is possible to secure the vibration damping performance well by smoothly guiding the second coupling shaft using the guide portion by swinging the second coupling shaft about the virtual axis so as to keep the interaxial distance between the first coupling shaft and the second coupling shaft and the interaxial distance between the virtual axis and the second coupling shaft constant. As a result, with the vibration damping device, it is possible to further improve the vibration damping performance while suppressing an increase in weight or size of the entire device. The support member may be the rotary element itself, or may be a member that is separate from the rotary element.

The vibration damping device (20) may be designed such that a center of the second coupling shaft (24) is not positioned closer to the center of rotation (RC) than a line that passes through the virtual axis (25) and that is orthogonal to a line segment that connects between the center of rotation (RC) and the virtual axis (25) when the second coupling shaft (24) swings about the virtual axis (25) as guided by the guide portion (235). Consequently, the second coupling shaft can be moved smoothly over the entire swing range, and thus it is possible to secure the vibration damping performance well.

The guide portion (235) may include a guide surface (236) in a recessed circular columnar surface shape, and the second coupling shaft (24) may move along the guide surface (236) along with rotation of the support member (16). Consequently, it is possible to swing the second coupling shaft about the first coupling shaft while keeping the interaxial distance between the first coupling shaft and the second coupling shaft constant, and to swing the second coupling shaft about the virtual axis while keeping the interaxial distance between the virtual axis and the second coupling shaft constant, along with rotation of the support member (rotary element). By forming the guide surface in a recessed circular columnar surface shape with a constant curvature, the second coupling shaft can be guided smoothly by the guide portion to stabilize torque fluctuations, which can secure the vibration damping performance well.

The vibration damping device (20) may further include: a plurality of rolling bodies (26); and an outer ring (27) that is rotatably supported by the second coupling shaft (24) via the plurality of rolling bodies (26) and that rolls on the guide surface (236). In such a vibration damping device, the plurality of rolling bodies such as balls and rollers, the outer ring, and the second coupling shaft constitute a rolling bearing. Consequently, a loss due to friction around the second coupling shaft can be reduced even if a tensile load based on a centrifugal force that acts on the second coupling shaft has become large. As a result, it is possible to improve the vibration damping performance well by causing the vibration order of the vibration damping device to approximate the order of target vibration to be damped.

The guide portion (235) may include a support surface (237) in a projecting curved surface shape, the support surface (237) located on an inner side in a radial direction of the rotary element (15, 16) with respect to the guide surface (236) and facing the guide surface (236). Consequently, it is possible to swing the restoring force generation member and the inertial mass body more adequately by supporting the second coupling shaft using the support surface when the rotational speed of the rotary element (support member) is low or when the rotary element (support member) is stationary. It should be noted, however, that the support surface may be omitted from the guide portion.

The first coupling shaft (21) may be rotatably supported by a sliding bearing portion provided on at least one of the support member and the restoring force generation member (16, 22). Consequently, it is possible to reduce the size and the weight of the entire device by simplifying the configuration around the first coupling shaft.

The inertial mass body (23) may include at least one annular member (230). Consequently, it is possible to eliminate the effect of a centrifugal force (and a centrifugal liquid pressure) that acts on the inertial mass body on swinging motion of the inertial mass body, and to increase the moment of inertia of the inertial mass body while suppressing an increase in weight of the inertial mass body.

The restoring force generation member (22) may include at least one plate member (220) that has an arcuate planar shape. Consequently, it is possible to reduce the effect, on the restoring force (a component force of the centrifugal force that acts on the restoring force generation member), of a force due to a centrifugal hydraulic pressure that acts on the restoring force generation member well in the case where the vibration damping device is disposed in oil.

The restoring force generation member (22) may include two plate members (220) that face each other in an axial direction of the rotary element (15, 16), the inertial mass body (23) may include two annular members (230) disposed between the two plate members (220) in the axial direction so as to face each other, and the support member (16) may be a single plate-like member disposed between the two annular members (230) in the axial direction. Consequently, it is possible to further improve the vibration damping performance by disposing the restoring force generation member and the inertial mass body on both sides of the single support member in a well-balanced manner while suppressing an increase in axial length of the vibration damping device by omitting a connecting member in a common four-node rotary link mechanism.

The guide portion (235) may be formed in the inertial mass body (23), and the second coupling shaft (24) may be supported by the restoring force generation member (22). Consequently, it is possible to suppress an increase in weight or size of the entire device while securing the required weight (moment of inertia) of the restoring force generation member and the inertial mass body. It should be noted, however, that the guide portion may be formed in the restoring force generation member, and that the second coupling shaft may be supported by the inertial mass body.

The support member (16) may rotate coaxially and together with a rotary element of a damper device (10, 10B, 10C) that has a plurality of rotary elements (11, 12, 121, 122, 15) including at least an input element (11) and an output element (15) and that has an elastic body (SP, SP1, SP2, SP3) that transfers torque between the input element (11) and the output element (15). By coupling the vibration damping device to the rotary element of the damper device in this way, it is possible to damp vibration significantly well using both the damper device and the vibration damping device while suppressing an increase in weight of the damper device.

The input element (11) of the damper device (10, 10B, 10C) may be functionally (directly or indirectly) coupled to an output shaft of a motor (EG). The output element (15) of the damper device (10, 10B, 10C) may be functionally (directly or indirectly) coupled to an input shaft (Is) of a transmission (TM).

Further, when the vibration damping device (20) is in the equilibrium state, a component force of the centrifugal force that acts on the restoring force generation member (22) along with rotation of the support member (16) in a direction that is orthogonal to the direction from the center of the first coupling shaft (21) toward the center of gravity (G) of the restoring force generation member (22) may become larger than zero. That is, in a vibration damping device such as that discussed above, a component force of the centrifugal force that acts on the restoring force generation member along with rotation of the support member in a direction that is orthogonal to the direction from the center of the first coupling shaft toward the center of gravity of the restoring force generation member acts as a restoring force (moment) that acts to return the restoring force generation member and the inertial mass body which is coupled thereto to the position in the equilibrium state. Thus, by configuring the vibration damping device such that the component force of the centrifugal force in the equilibrium state is more than zero, the restoring force for the same centrifugal force which acts on the restoring force generation member can be increased compared to a case where the component force of the centrifugal force which acts on the restoring force generation member in the equilibrium state is zero. Thus, with the vibration damping device, it is possible to increase the equivalent rigidity of the vibration damping device while suppressing an increase in weight of the restoring force generation member, which can improve the degree of freedom in setting of the equivalent rigidity and the equivalent mass, that is, the vibration order. As a result, it is possible to further improve the vibration damping performance while suppressing an increase in weight or size of the restoring force generation member and hence the entire device. It should be noted, however, that the vibration damping device according to the present disclosure may be configured such that a component force of the centrifugal force that acts on the restoring force generation member in the equilibrium state in a direction that is orthogonal to the direction from the center of the first coupling shaft toward the center of the second coupling shaft is larger than zero.

The restoring force generation member (22) may be swung about the first coupling shaft (A21) between a position in the equilibrium state and a turn-back position at which the restoring force generation member (22) has been rotated in one direction about the first coupling shaft (21) from the position in the equilibrium state, and the inertial mass body (23) may be swung about the center of rotation (RC) within the swing range which is centered on the position in the equilibrium state. That is, in such a vibration damping device, while the inertial mass body is always rotated in the direction opposite the direction (in the phase opposite the phase) of rotation of the rotary element (support member) about the center of rotation, the restoring force generation member is not only rotated in the direction opposite the direction (in the phase opposite the phase) of rotation of the rotary element etc. about the coupling shaft, but also rotated in the same direction as (in the same phase as) the rotary element etc. Consequently, it is possible to reduce the effect of the weight of the restoring force generation member on the equivalent mass of the vibration damping device.

While the restoring force generation member (22) makes motion of moving from the position in the equilibrium state to the turn-back position and returning from the turn-back position to the position in the equilibrium state twice, the inertial mass body (23) may move from the position in the equilibrium state to one end of the swing range, thereafter return to the position in the equilibrium state, further move to the other end of the swing range, and thereafter return to the position in the equilibrium state. Consequently, it is possible to reduce the vibration angle (swing range) of the restoring force generation member about the coupling shaft, and to increase the restoring force which acts on the restoring force generation member (and the inertial mass body) which is swung.

When an interaxial distance between the center of rotation (RC) of the rotary element (15, 16) and the first coupling shaft (21) is defined as “L1”, an interaxial distance between the first coupling shaft (21) and the second coupling shaft (24) is defined as “L2”, an interaxial distance between the second coupling shaft (24) and the virtual axis (25) is defined as “L3”, and an interaxial distance between the virtual axis (25) and the center of rotation (RC) is defined as “L4”, the vibration damping device (20) may meet L1+L2>L3+L4.

In this way, by configuring the vibration damping device so as to meet the relationship L1+L2>L3+L4, the angle which is formed by the direction of the centrifugal force which acts on the restoring force generation member and the direction from the center of the first coupling shaft, which couples the support member and the restoring force generation member to each other, toward the center of gravity of the restoring force generation member can be approximated to 90°. That is, with such a vibration damping device, it is possible to approximate the direction of the restoring force which acts on the restoring force generation member (a component force of the centrifugal force) to the direction of the centrifugal force. Consequently, the restoring force for the same centrifugal force which acts on the restoring force generation member can be increased compared to a case where the relationship L1+L2>L3+L4 is not met, which makes it possible to increase the equivalent rigidity of the vibration damping device while suppressing an increase in weight of the restoring force generation member. In the case where the relationship L1+L2>L3+L4 is met, further, swinging motion of the restoring force generation member is restricted (the vibration angle is reduced) compared to the inertial mass body, and while the inertial mass body is always rotated in the direction opposite the direction (in the phase opposite the phase) of rotation of the rotary element (support member) about the center of rotation, the restoring force generation member is not only rotated in the direction opposite the direction (in the phase opposite the phase) of rotation of the rotary element about the first coupling shaft, but also rotated in the same direction as (in the same phase as) the rotary element. Consequently, the effect of the weight of the restoring force generation member on the equivalent mass of the vibration damping device can be made very small, which can further improve the degree of freedom in setting of the equivalent rigidity and the equivalent mass, that is, the vibration order. As a result, it is possible to improve the vibration damping performance significantly well while suppressing an increase in weight or size of the restoring force generation member and hence the entire device.

The interaxial distance L3 may be shorter than the interaxial distances L1, L2, and L4. That is, the equivalent rigidity of the vibration damping device discussed above is inversely proportional to the square value of the ratio (L3/(L3+L4)) of the interaxial distance L3 to the sum of the interaxial distances L3 and L4. Thus, by making the interaxial distance L3 shorter than the interaxial distances L1, L2, and L4, it is possible to increase the equivalent rigidity while suppressing an increase in weight of the restoring force generation member. Additionally, the vibration angle of the restoring force generation member can be reduced by making the interaxial distance L3 shorter, which makes it possible to further reduce the effect of the weight of the restoring force generation member on the equivalent mass, and to make the entire device compact. With the vibration damping device according to the present disclosure, it is not necessary to provide a bearing such as a sliding bearing or a rolling bearing on the virtual axis, and thus it is possible to easily shorten the interaxial distance L3.

The interaxial distance L1 may be longer than the interaxial distances L2, L3, and L4. Consequently, the center of gravity of the restoring force generation member can be positioned on the radially outer side with the restoring force generation member spaced away from the center of rotation of the rotary element, which makes it possible to increase the component force of the centrifugal force which acts on the restoring force generation member, that is, the restoring force. Additionally, by making the interaxial distance L1 the longest while meeting the relationship L1+L2>L3+L4, the restoring force generation member can be disposed along a circumference that passes through the center of the first coupling shaft and that is centered on the center of rotation, and the vibration angle of the restoring force generation member can be reduced. Consequently, it is possible to reduce the effect, on the restoring force, of a force due to a centrifugal hydraulic pressure that acts on the restoring force generation member, and to reduce fluctuations in force due to the centrifugal hydraulic pressure which is caused when the restoring force generation member is swung, in the case where the vibration damping device is disposed in oil.

The vibration damping device (20) may be configured to meet L1>L4>L2>L3. Consequently, it is possible to secure practically good equivalent rigidity of the vibration damping device, and to reduce the effect of the weight of the restoring force generation member on the equivalent mass of the vibration damping device to be practically ignorable.

The vibration damping device (20) may be configured to meet L1+L2<L3+L4. Consequently, it is possible to swing the restoring force generation member and the inertial mass body stably and smoothly by eliminating a change point in the four-node rotary link mechanism. In this case, the interaxial distance L2 may be shorter than the interaxial distances L1, L3, and L4. In such a vibration damping device, the support member, the restoring force generation member, the inertial mass body, the first and second coupling shafts, and the guide portion substantially constitute a lever crank mechanism in which the support member (rotary element) serves as a fixed node and swinging motion of the restoring force generation member is converted into swinging motion of the inertial mass body. Thus, with such a vibration damping device, it is possible to further increase a moment about the center of rotation that acts on the inertial mass body when the restoring force generation member has started to swing with respect to the support member from the position in the equilibrium state, and to further increase a restoring force that acts on the inertial mass body when the restoring force generation member has reached one end of the swing range.

The invention according to the present disclosure is not limited to the embodiment described above in any way, and it is a matter of course that the invention may be modified in various ways without departing from the range of the extension of the present disclosure. Further, the mode for carrying out the invention described above is merely a specific form of the invention described in the “SUMMARY” section, and does not limit the elements of the invention described in the “SUMMARY” section.

### INDUSTRIAL APPLICABILITY

The invention according to the present disclosure can be utilized in the field of manufacture of vibration damping devices that damp vibration of a rotary element.

1. A vibration damping device that damps vibration of a rotary element, comprising:
a support member that rotates about a center of rotation of the rotary element together with the rotary element;
a restoring force generation member rotatably coupled to the support member via a first coupling shaft;
an inertial mass body that is rotatable about the center of rotation;
a second coupling shaft that is supported by one of the restoring force generation member and the inertial mass body and that couples the restoring force generation member and the inertial mass body so that the restoring force generation member and the inertial mass body are rotatable relative to each other; and
a guide portion that is formed in the other of the restoring force generation member and the inertial mass body and that guides the second coupling shaft, along with rotation of the support member, such that the second coupling shaft swings about the first coupling shaft while keeping an interaxial distance between the first coupling shaft and the second coupling shaft constant, and such that the second coupling shaft swings about a virtual axis, a relative position of which with respect to the inertial mass body is determined to be invariable, while keeping an interaxial distance between the virtual axis and the second coupling shaft constant.

2. The vibration damping device according to claim 1, wherein
the vibration damping device is designed such that a center of the second coupling shaft is not positioned closer to the center of rotation than a line that passes through the virtual axis and that is orthogonal to a line segment that connects between the center of rotation and the virtual axis when the second coupling shaft swings about the virtual axis as guided by the guide portion.

3. The vibration damping device according to claim 1, wherein
the guide portion includes a guide surface in a recessed circular columnar surface shape, and
the second coupling shaft moves along the guide surface along with rotation of the support member.

4. The vibration damping device according to claim 3, further comprising:
a plurality of rolling bodies; and
an outer ring that is rotatably supported by the second coupling shaft via the plurality of rolling bodies and that rolls on the guide surface.

5. The vibration damping device according to claim 3, wherein
the guide portion includes a support surface in a projecting curved surface shape, the support surface located on an inner side in a radial direction of the rotary element with respect to the guide surface and facing the guide surface.

6. The vibration damping device according to claim 1, wherein
the first coupling shaft is rotatably supported by a sliding bearing portion provided on at least one of the support member and the restoring force generation member.

7. The vibration damping device according to claim 1, wherein
the inertial mass body includes at least one annular member.

8. The vibration damping device according to claim 1, wherein
the restoring force generation member includes at least one plate member that has an arcuate planar shape.

9. The vibration damping device according to claim 1, wherein
the restoring force generation member includes two plate members that face each other in an axial direction of the rotary element,
the inertial mass body includes two annular members disposed between the two plate members in the axial direction so as to face each other, and
the support member is a single plate-like member disposed between the two annular members in the axial direction.

10. The vibration damping device according to claim 1, wherein
the guide portion is formed in the inertial mass body, and the second coupling shaft is supported by the restoring force generation member.

11. The vibration damping device according to claim 1, wherein
the support member rotates coaxially and together with a rotary element of a damper device that has a plurality of rotary elements including at least an input element and an output element and that has an elastic body that transfers torque between the input element and the output element.

12. The vibration damping device according to claim 11, wherein
the input element of the damper device is functionally coupled to an output shaft of a motor.

13. The vibration damping device according to claim 11 or 12, wherein
the output element of the damper device is functionally coupled to an input shaft of a transmission.

14. The vibration damping device according to claim 2, wherein
the guide portion includes a guide surface in a recessed circular columnar surface shape, and
the second coupling shaft moves along the guide surface along with rotation of the support member.

15. The vibration damping device according to claim 14, further comprising:
a plurality of rolling bodies; and
an outer ring that is rotatably supported by the second coupling shaft via the plurality of rolling bodies and that rolls on the guide surface.

16. The vibration damping device according to claim 4, wherein
the guide portion includes a support surface in a projecting curved surface shape, the support surface located on an inner side in a radial direction of the rotary element with respect to the guide surface and facing the guide surface.

17. The vibration damping device according to claim 2, wherein
the first coupling shaft is rotatably supported by a sliding bearing portion provided on at least one of the support member and the restoring force generation member.

18. The vibration damping device according to claim 2, wherein
the inertial mass body includes at least one annular member.

19. The vibration damping device according to claim 2, wherein
the restoring force generation member includes at least one plate member that has an arcuate planar shape.

20. The vibration damping device according to claim 2, wherein
the restoring force generation member includes two plate members that face each other in an axial direction of the rotary element,
the inertial mass body includes two annular members disposed between the two plate members in the axial direction so as to face each other, and
the support member is a single plate-like member disposed between the two annular members in the axial direction.
